(19) United States
(12) Patent Application Publication
(10) Pub. No.: US 2014/0237431 A1
(43) Pub. Date: Aug. 21, 2014

(54) ENDOSCOPE IMAGE MANAGEMENT APPARATUS AND ENDOSCOPE IMAGE DISPLAY METHOD

(71) Applicant: Olympus Corporation, Tokyo (JP)

(72) Inventor: Saichi SATO, Sagamihara-shi (JP)

(73) Assignee: Olympus Corporation, Tokyo (JP)

(21) Appl. No.: 14/015,256

(22) Filed: Aug. 30, 2013

(30) Foreign Application Priority Data
Feb. 21, 2013 (JP) 2013-032397

(51) Int. Cl. G06F 3/0481

(52) U.S. Cl. CPC G06F 3/0481
USPC 715/853

(57) ABSTRACT

An endoscope apparatus displays a folder tree on a screen of an LCD, the folder tree including multiple folders according to zones in which endoscope image files are registered and multiple folders according to dates set as a hierarchical layer higher than the multiple folders according to zones. The endoscope apparatus extracts folder names of lower folders which include at least one endoscope image file, the lower folders being included in each of the multiple higher folders, as virtual folder names, based on folder names of the multiple folders, collects and integrates the same folder names, associates endoscope image files included in folders having the same folder name with the extracted virtual folder, and displays endoscope images associated with the selected virtual folder.

This application claims benefit of Japanese Application No. 2013-32397 filed in Japan on Feb. 21, 2013, the contents of which are incorporated by this reference.

### BACKGROUND OF THE INVENTION

1. Field of the Invention

The present invention relates to an endoscope image management apparatus and an endoscope image display method.

2. Description of the Related Art

Conventionally, endoscope apparatuses have been widely used in industrial and medical fields. The endoscope apparatuses are used for examinations of various targets or patients, and a great number of endoscope images are obtained in the examinations. Since the great number of endoscope images are recorded in a storage device or an external storage device of an endoscope apparatus, the endoscope apparatus includes software for managing data so that data can be retrieved and consulted, and the endoscope apparatus is configured so that registered endoscope images can be retrieved and consulted with the use of the software. The endoscope image data recorded in the endoscope apparatus is similarly managed by the software for managing data (hereinafter referred to as data management software) in a personal computer (hereinafter referred to as a PC) also, and the endoscope image data is configured so that the endoscope images can be retrieved and consulted.

In many cases, the data management software mounted on the endoscope apparatus and the PC is equipped with a function of creating a folder. Therefore, a user creates various folders and registers multiple endoscope image data about an examination target in the folders so as to make it easy to retrieve and consult endoscope images afterward.

Therefore, when performing management of endoscope images using folders, the user can create a folder for each examination target and for each examination zone. By creating a folder for each examination target and for each examination zone, the user can easily retrieve and consult endoscope examination images for each examination zone and for each examination target.

There may be a case where endoscope examination is performed for the same examination target periodically, for example, every month. In such a case, the user may use functions of the data management software to create folders according to dates or the like as a hierarchy layer lower than the folder for the examination target and register image data for respective examination dates with the folders.

By creating such folders according to dates or the like, the user can perform management of endoscope image data for each examination date.

### SUMMARY OF THE INVENTION

An endoscope image management apparatus of one aspect of the present invention includes: a folder tree display processing section which displays a folder tree on a screen of a display device, the folder tree including multiple folders in which endoscope image files are registered and multiple higher folders set as a hierarchical layer higher than the multiple folders; a virtual folder generating section which extracts folder names of lower folders which include at least one endoscope image file, the lower folders being included in each of the multiple higher folders, as virtual folder names, based on folder names of the multiple folders, collects and integrates the same folder names, and associates endoscope image files included in folders having the same folder name with the extracted virtual folder; a virtual folder display processing section which displays the extracted virtual folders on the screen; and an image display processing section which, when the virtual folder displayed on the screen is selected, displays endo scope images of one or more endoscope image files associated with the selected virtual folder, on the screen.

An endoscope image display method of one aspect of the present invention is a method for displaying endoscope images of endoscope image files registered with multiple folders, the method including: displaying a folder tree on a screen of a display device by a folder tree display processing section, the folder tree including multiple folders in which endoscope image files are registered and multiple higher folders set as a hierarchical layer higher than the multiple folders; extracting folder names of lower folders which include at least one endoscope image file, the lower folders being included in each of the multiple higher folders, as virtual folder names, based on folder names of the multiple folders, collecting and integrating same folder names, and associating endoscope image files included in folders having a same folder name with the extracted virtual folder, by a virtual folder generating section; displaying the extracted virtual folders on the screen by a virtual folder display processing section; and when the virtual folder displayed on the screen is selected, displaying endoscope images of one or more endoscope image files associated with the selected virtual folder, on the screen, by an image display processing section.

### BRIEF DESCRIPTION OF THE DRAWINGS

FIG. 1 is an external configuration diagram of an endoscope apparatus according to an embodiment of the present invention;

FIG. 2 is a block diagram for illustrating an internal circuit configuration of a body part 2 of an endoscope apparatus 1 according to the embodiment of the present invention;

FIG. 3 is a diagram for illustrating an example of folders in a hierarchical structure according to the embodiment of the present invention;

FIG. 4 is a diagram showing a configuration example of an endoscope image management screen displayed on an LCD 4 of the body part 2 according to the embodiment of the present invention;

FIG. 5 is a flowchart showing an example of a flow of a management screen display process by a CPU 21 of the endoscope apparatus 1 according to the embodiment of the present invention;

FIG. 6 is a flowchart showing an example of a flow of a process for displaying a virtual folder for a selected examination target and displaying image data for the selected virtual folder according to the embodiment of the present invention;

FIG. 7 shows an example of a list of full pathnames of all files of image data acquired when a folder “ENGINE1_SN001” is selected, according to the embodiment of the present invention;

FIG. 8 is a diagram for illustrating a list of file pathnames for each virtual folder name, the file pathnames being sorted in order of date, according to the embodiment of the present invention;

FIG. 9 is a diagram showing a display example of the management screen when an examination-target folder is selected, according to the embodiment of the present invention;

FIG. 10 is a diagram showing a display example of the management screen when a certain virtual folder is selected, according to the embodiment of the present invention;

FIG. 11 is a diagram showing a display example of a sample image in the management screen when a certain image is selected, according to the embodiment of the present invention;

FIG. 12 is a diagram for illustrating an example of folders in a hierarchical structure according to another embodiment of the present invention;

FIG. 13 is a flowchart showing an example of a flow of a process for displaying a virtual folder for a selected examination target and displaying image data for the selected virtual folder according to the other embodiment of the present invention;

FIG. 14 is a flowchart showing an example of a flow of a process for displaying a virtual folder for a selected examination target and displaying image data for the selected virtual folder according to the other embodiment of the present invention;

FIG. 15 shows an example of a list of full pathnames of all folders and all files of image data acquired when a folder “ENGINE1_SN001” is selected, according to the other embodiment of the present invention;

FIG. 16 is a diagram for illustrating a list of file pathnames for each virtual folder name, the file pathnames being sorted in order of date, according to the other embodiment of the present invention;

FIG. 17 is a diagram showing an example of a list which includes information about existence/nonexistence of files, folder paths and folder creation dates and time as a list for virtual folders having the same name, according to the other embodiment of the present invention;

FIG. 18 is a diagram showing an example of a list which includes information about existence/nonexistence of file, folder paths and folder creation dates and time as a list for virtual folders having the same name, according to the other embodiment of the present invention;

FIG. 19 is a diagram showing a display example of the management screen when an independent folder is identifiably displayed, according to the other embodiment of the present invention;

FIG. 20 is a diagram showing a display example of the management screen when a certain virtual folder is selected, according to the other embodiment of the present invention;

FIG. 21 is a diagram showing a display example of the management screen in the case where a virtual folder “IPT_STAGE1_ZONE2” is selected, according to the other embodiment of the present invention;

FIG. 22 is a diagram showing a display example of the management screen in the case where a virtual folder “LPT_STAGE2_ZONE1” is selected, according to the other embodiment of the present invention;

FIG. 23 is a diagram for illustrating an example of folders in a hierarchical structure according to a modification of the present invention;

FIG. 24 is a flowchart showing an example of a flow of a process executed when a virtual folder is selected in a state in which the management screen is displayed, according to the modification of the present invention;

FIG. 25 is a display example of the management screen in the case where an image changes from “nonexistence of abnormality” to “existence of abnormality”, according to the modification of the present invention; and

FIG. 26 is a display example of the management screen in the case where an image changes from “existence of abnormality” to “nonexistence of abnormality”, according to the modification of the present invention.

### DETAILED DESCRIPTION OF THE PREFERRED EMBODIMENTS

Embodiments of the present invention will be described below with reference to drawings.

### (Whole Configuration)

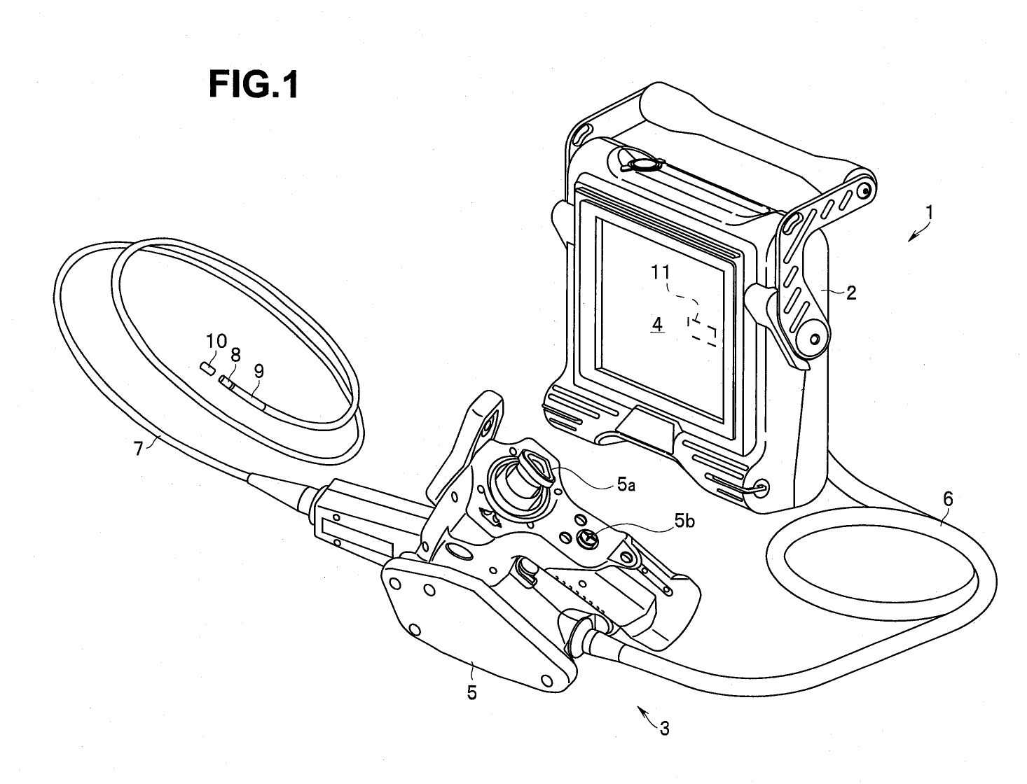

FIG. 1 is an external configuration diagram of an endoscope apparatus according to an embodiment.

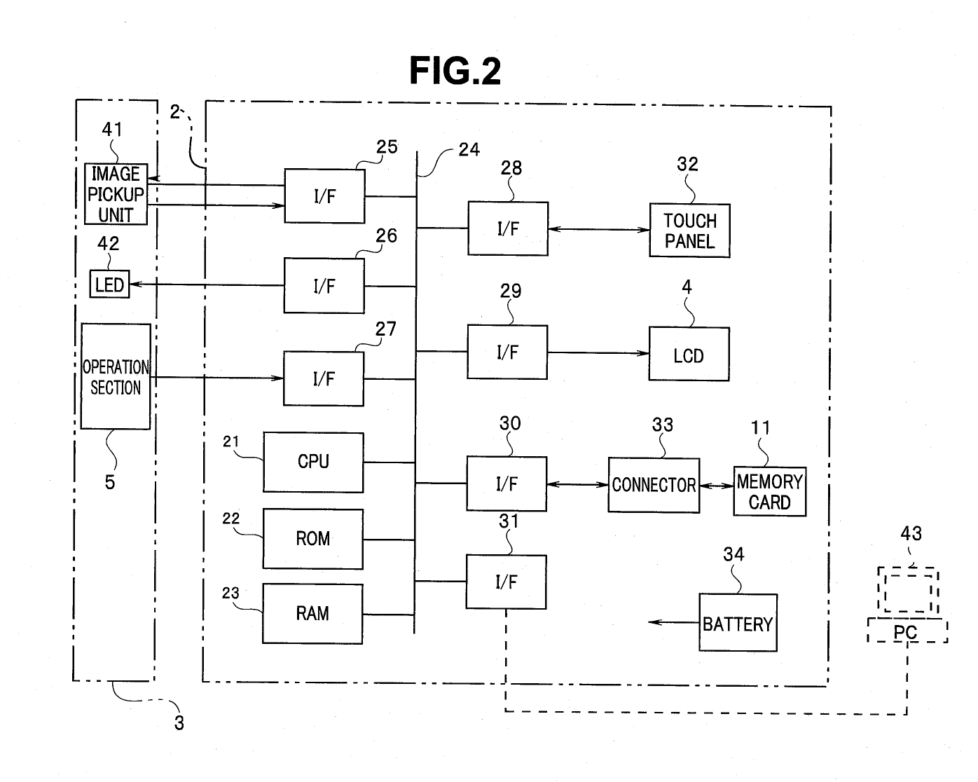

As shown in FIG. 1, an endoscope apparatus 1 is configured including a body part 2, which is a main unit, and a scope unit 3 connected to the body part 2. The body part 2 has a liquid crystal display section (hereinafter referred to as an LCD) 4 as a display device on which an endoscope image, an operation menu and the like are displayed. The LCD 4 is a display section which displays an endoscope image. As described later, the LCD 4 is provided with a touch panel (FIG. 2).

The scope unit 3 has an operation section 5 connected to the body part 2 via a universal cable 6, which is a connection cable, and an insertion portion 7 which includes a flexible insertion tube and is connected to the operation section 5. The scope unit 3 is attachable to and detachable from the body part 2. A distal end portion 8 of the insertion portion 7 includes an image pickup unit (FIG. 2) to be described later.

The image pickup unit is configured by an image pickup device, for example, a CCD or a CMOS sensor, and an image pickup optical system, such as a lens arranged on the image pickup surface side of the image pickup device. A bending portion 9 is provided on the proximal end side of the distal end portion 8. An optical adapter 10 can be attached to the distal end portion 8. The operation section 5 is provided with various operation buttons such as a freeze button and a recording instruction button (hereinafter referred to as a REC button).

A user can operate the various operation buttons of the operation section 5 to perform image pickup of an object, recording of a still image and the like. The operation section 5 is further provided with joy sticks 5a and 5b. The user can bend the bending portion 9 by operating the joy stick 5a. Furthermore, in the case of changing a recording-destination folder of an endoscope image to be described later, the user can select a recording-destination folder from a group of folders in a menu screen displayed on the screen of the LCD 4 by performing an operation of tilting the joy stick 5b provided for the operation section 5 in any of upward, downward, rightward and leftward directions. The user can also instruct various operations of the endoscope apparatus 1 by operating the touch panel. That is, the touch panel constitutes an instruction inputting section for instructing contents of operation of the endoscope apparatus 1.

Image data of an endoscope image obtained by performing image pickup is examination data of an examination target and recorded to a memory card 11 which is a recoding medium. The memory card 11 is attachable to and detachable from the body part 2.

Note that, though image data is recorded to the memory card 11 as a recording medium attachable to and detachable from the body part 2 in the embodiment, image data may be recorded to a memory included in the body part 2.

The user can bring the distal end portion 8 of the insertion portion 7 to an examination zone of an examination target, photograph the examination zone and display an endoscope image on the LCD 4. Furthermore, the user can record endoscope image data to the memory card 11 while confirming a folder in the memory card 11 to which the endoscope image is to be recorded at the time of examination, and, if necessary, can operate the operation section 5 to change the recording-destination folder of the endoscope image.

### (Circuit Configuration)

FIG. 2 is a block diagram for illustrating an internal circuit configuration of the body part 2 of the endoscope apparatus 1.

The body part 2 includes a central processing unit (hereinafter referred to as a CPU) 21, a ROM 22 and a RAM 23, which are mutually connected via a bus 24. Furthermore, multiple various kinds of interfaces (hereinafter referred to as I/Fs) 25 to 31 are connected to the bus 24. The I/F 25 is a drive/reception circuit for performing transmission of a drive signal to an image pickup unit 41 of the scope unit 3 and reception of an image pickup signal from the image pickup unit 41. The I/F 26 is a drive circuit for transmitting a drive signal to an LED 42 as an illumination section.

The I/F 27 is a circuit for receiving various operation signals from the operation section 5. The various operation signals from the operation section 5 include operation signals of the joy sticks 5a and 5b. The LCD 4 is provided with a touch panel 32, and the I/F 28 is provided as a circuit for receiving a drive signal to the touch panel 32 and an operation signal from the touch panel 32. The I/F 29 is a circuit for supplying an image data signal to the LCD 4.

The I/F 30 is a circuit for writing image data to the memory card 11 and reading image data from the memory card 11. The I/F 30 is connected to the memory card 11 via a connector 33 provided for the body part 2. The memory card 11 is detachably fitted to the connector 33.

The I/F 31 is a circuit for connecting a PC (personal computer) 43, which is an external apparatus, to the body part 2. The PC 43 is connected to the body part 2 via a connector not shown, and the body part 2 can exchange data with the PC 43 via the I/F 31 connected to the connector.

The body part 2 includes a battery 34 inside, and the battery 34 supplies a power source to the various circuits in the body part 2.

Each I/F operates under the control of the CPU 21. When the endoscope apparatus 1 is booted, the CPU 21 outputs various drive signals to the image pickup unit 41 via the I/F 25, and the image pickup unit 41 outputs an image pickup signal to the CPU 21. The CPU 21 outputs a drive instruction signal to drive the LED 42, to the PF 26. Being driven by output of the I/F 26, the LED 42 illuminates an object, and, as a result, a live image is displayed on the LCD 4.

Since the operation section 5 is connected to the CPU 21 via the I/F 27, the operation section 5 supplies various operation signals showing contents of operations performed by the user against the operation section 5, to the CPU 21. When the user presses the freeze button to be described later, the CPU 21 generates a still image based on an image pickup signal from the image pickup unit 41. When the user further presses the REC button, image data of the still image is recorded to the memory card 11. Since a still image generated by freezing is displayed on the LCD 4, the user can confirm the still image. If the still image is to be recorded, the user presses the REC button.

The endoscope apparatus 1 is also an endoscope image management apparatus which records and manages endoscope image data. As described later, it is possible to display a management screen on the screen of the LCD 4, which is a display device, and see endoscope images in each folder.

### (Folder Configuration)

The user can create any folder in the memory card 11. The user may perform the folder creation work on an external apparatus such as the PC 43 or by connecting a hardware keyboard to the endoscope apparatus 1 and operating the hardware keyboard. The user may perform the folder creation work by operating a setting screen displayed on the LCD 4 and a software keyboard configured as a GUI. For example, the user creates multiple folders having a hierarchical structure in the memory card 11 using the PC 43 before an endoscope examination. Note that it is not possible to give the same folder name to multiple folders within the same hierarchy layer. However, among folders at a further lower hierarchical layer (grandchildren) under different folders (children) at a lower layer branched from the same higher folder (parent), folders having the same name can be created.

More specifically, for example, the user can create multiple folders having desired folder names under “root” and can store endoscope images in each folder. It is also possible for the user to further create a folder under the folder. However, the user cannot create multiple folders having the same name at a hierarchical layer immediately under “root”. The user can create folders having the same name at respective lower hierarchical layers of different folders created at the hierarchical layer created immediately under “root”. That is, the user can create folders having a hierarchical structure in a recording medium. The user can record an endoscope image obtained by performing image pickup by the image pickup unit 41 of the scope unit 3 to a desired folder.

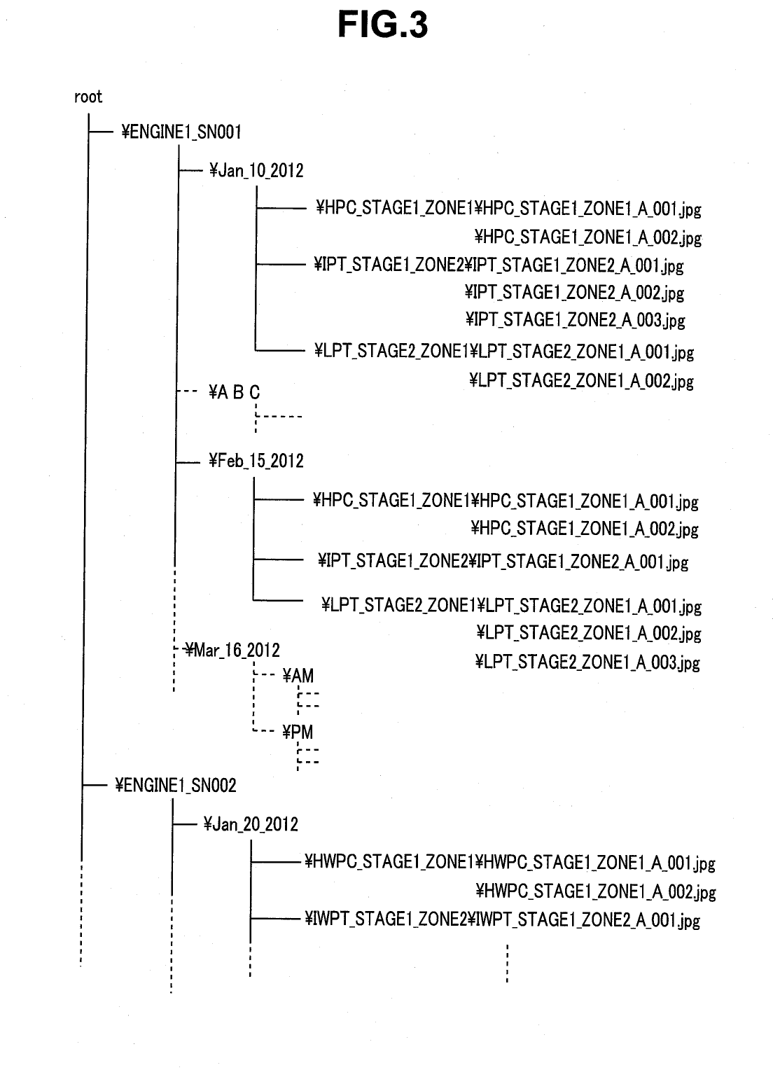

FIG. 3 is a diagram for illustrating an example of folders in a hierarchical structure according to the embodiment. Note that FIG. 3 schematically expresses each folder and files included in the folder to explain the folders in a hierarchical structure and that an example is shown here in which a folder has three hierarchical layers, that is, three levels.

Endoscope examination is regularly or irregularly performed for one examination target, for example, an aircraft engine, piping or the like. In such a case, the user uses the functions of the data management software to create folders according to dates as a hierarchy layer lower than the folder for the examination target and registers image data for respective examination dates with the folders according to dates.

By creating such folders according to dates, the user can perform management of endoscope image data for each examination date.

Note that, though an example of creating folder names according to dates will be shown below, the folder names do not have to include characters or the like indicating a date. For example, as indicated by broken lines in FIG. 3, a folder “ABC” is possible as a folder which does not include characters indicating a date, in addition to folders according to dates, “Jan_{—}10_{—}2012” and “Feb_{—}15_{—}2012”.

As shown in FIG. 3, a folder “ENGINE1_SN001” is created as an examination-target folder at a hierarchical layer lower than “root”, and a group of folders according to dates is created under the folder “ENGINE1_SN001”. For example, “ENGINE1_SN001” is a folder name indicating an engine name and a manufacturer's serial number. In FIG. 3, the folders according to dates, “Jan_{—}10_{—}2012” and “Feb_{—}15_{—}2012” are created under the folder “ENGINE1_SN001”. Here, a group of the folders according to dates for respective dates on which examination is performed is created.

Furthermore, a group of folders according to zones, which are folders for respective examination zones, is created at a hierarchical layer lower than the folders according to dates. In FIG. 3, folders according to zones, “HPC_STAGE1_ZONE1”, “IPT_STAGE1_ZONE2” and “LPT_STAGE2_ZONE1” are created at a hierarchical layer lower than each of the folders according to dates.

The group of folders according to zones is determined in advance for the examination target “ENGINE1_SN001”. That is, the folder “ENGINE1_SN001” is a folder for a particular engine, and image data which is endoscope examination data of the engine is recorded to a corresponding folder among multiple (here, three) folders according to zones as lower-hierarchy-layer folders so that the image data can be recorded according to zones determined in advance. Here, the three folders according to zones, “HPC_STAGE1_ZONE1”, “IPT_STAGE1_ZONE2” and “LPT_STAGE2_ZONE1” are determined in advance for “ENGINE1_SN001”, and they are set at a hierarchical layer lower than the folder “ENGINE1_SN001”.

As described above, folders according to dates can be set at a layer lower than the “ENGINE1_SN001” folder for the certain particular engine, and multiple folders according to zones which are set for the “ENGINE1_SN001” folder in advance and which are common to the folders according to dates are set for each of the folders according to dates. The user can select a folder according to zone in which the endoscope image data is to be registered and register the endoscope image data with the selected folder according to zone.

Image data of endoscope examination performed by the user on a certain day (for example, Jan. 10, 2012) is registered with the folder “Jan_{—}10_{—}2012” of the folder “ENGINE1_SN001”, and the image data is registered with any of the three folders “HPC_STAGE1_ZONE1”, “IPT_STAGE1_ZONE2” and “LPT_STAGE2_ZONE1” lower than the folder “Jan_{—}10_{—}2012”.

Image data of endoscope examination performed by the user on another certain day (for example, Feb. 15, 2012) is registered with the folder “Feb_{—}15_{—}2012” of the folder “ENGINE1_SN001”, and the image data is registered with any of the three folders “HPC_STAGE1_ZONE1”, “IPT_STAGE1_ZONE2” and “LPT_STAGE2_ZONE1” lower than the folder “Feb_{—}15_{—}2012”. The folders “Jan_{—}10_{—}2012” and “Feb_{—}15_{—}2012” have the same group of lower-layer folders according to zones, that is, the three folders according to zones, “HPC_STAGE1_ZONE1”, “IPT_STAGE1_ZONE2” and “LPT_STAGE2_ZONE1”.

Though the folders according to dates are daily folders in the embodiment, they may be based on another measure of time. For example, they may be weekly folders, monthly folders or yearly folders. Otherwise, they may be created under a name which does not include indication of date and time (for example, “ABC” in FIG. 3).

As described above, a folder for a certain examination target includes a group of folders according to dates, and the group of folders according to dates includes a group of folders according to zones having the same names common to the folders. Furthermore, each of the folders according to zones may have hierarchized multiple folders at a lower layer, and each of the folders according to dates may also have hierarchized multiple folders (for example, “¥AM” and “¥PM” lower than “Mar_{—}16_{—}2012” in FIG. 3) as indicated by broken lines in FIG. 3.

As shown in FIG. 3, if there is another examination target in addition to the examination target engine (“ENGINE1_SN001”), the user can create another examination-target folder (for example, a folder “ENGINE1_SN002”) at the same hierarchical layer as the folder “ENGINE1_SN001” and create a group of folders according to dates for that other examination-target folder similarly to the folder “ENGINE1_SN001”.

Note that the group of folders according to dates of that other examination-target folder (“ENGINE1_SN002”) includes a group of folders according to zones (for example, folders “HWPC_STAGE1_ZONE1”, “IWPT_STAGE1_ZONE2” and the like as shown in FIG. 3) having the same names common to the folders and corresponding to that other examination target. Furthermore, note that the hierarchical layer of the folder for that other examination target (“ENGINE1_SN002”) may be different from the hierarchical layer of the folder “ENGINE1_SN001”.

Therefore, in the case where there are multiple examination targets, and the user performs endoscope examination for a certain examination target one day, the user creates folders according to dates at a layer lower than a folder for the examination target (for example, “ENGINE1_SN001”), creates multiple groups of folders according to zones determined in advance for the examination target as folders lower than the folders according to dates, executes endoscope examination and records image data.

For example, when endoscope examination is performed for the engine of “ENGINE1_SN001” on Feb. 15, 2012, the folder “Feb_{—}15_{—}2012” is created as a lower-layer folder of the folder “ENGINE1_SN001”, and the three folders according to zones, “HPC_STAGE1_ZONE1”, “IPT_STAGE1_ZONE2” and “LPT_STAGE2_ZONE1” are created or copied as lower-layer folders of the folder “Feb_{—}15_{—}2012”.

Then, when the user performs an endoscope image recording operation in a state in which a folder according to zone in which image data of an endoscope image is to be registered is selected, by operating the joy stick 5b provided for the operation section 5 on the screen of the LCD 4, the image data of the endoscope image is registered with the selected folder according to zone.

### (Configuration of Management Screen)

A screen for managing image data of endoscope examination will be described.

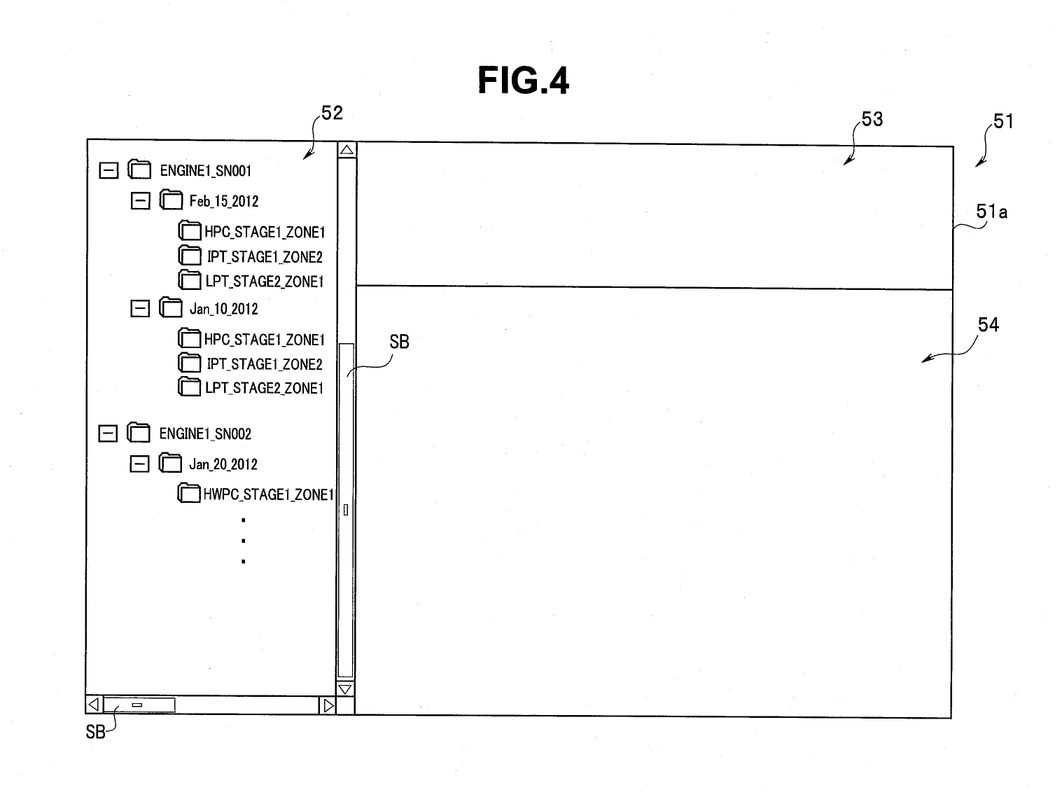

FIG. 4 is a diagram showing a configuration example of an endoscope image management screen displayed on the LCD 4 of the body part 2. A management screen 51 includes a folder tree display window 52, a virtual folder display window 53 and an image display window 54.

The folder tree display window 52 is a display area for displaying a folder tree for an examination target created by the user. In FIG. 4, the folders “ENGINE1_SN001” and “ENGINE1_SN002” are displayed as folders according to examination targets under “root”. As folders at a hierarchical layer lower than the folder “ENGINE1_SN001”, the two folders according to dates, “Jan_{—}10_{—}2012” and “Feb_{—}15_{—}2012” are displayed. As folders at a hierarchical layer lower than each of the folders according to dates, the three folders according to zones, “HPC_STAGE1_ZONE1”, “IPT_STAGE1_ZONE2” and “LPT_STAGE2_ZONE1” are displayed.

Similarly, the other examination-target folder “ENGINE1_SN002” also includes a group of folders according to dates corresponding to dates on which examination is performed, and each of the folders according to dates includes a group of folders according to zones corresponding to examination zones of an engine corresponding to “ENGINE1_SN002”. A file of endoscope image data is registered with each of the folders according to zones.

As described above, in the folder tree display window 52, a folder tree showing a folder tree structure is shown, the folder tree structure including multiple folders according to zones in which an endoscope image file is registered and multiple folders according to dates corresponding to endoscope image file registration time which are set as hierarchical layers higher than the multiple folders according to zones.

The virtual folder display window 53 is a display area for displaying a group of virtual folders for an examination target selected in the folder tree display window 52. As described later, a virtual folder is a folder which is generated for folders according to zones having the same folder name included in multiple folders according to dates. Endoscope image files included in the folders according to zones having the same folder name are associated with the virtual folder.

As described later, the image display window 54 is a display area for displaying an endoscope image of image data included in a virtual folder selected in the virtual folder display window 53.

Note that a scroll bar SB for performing scrolling display is provided for the folder tree display window 52 in FIG. 4, and the scroll bar SB is also displayed for the other display areas 53 and 54 when necessary.

Furthermore, note that display of various tool bars and the like for the management screen is omitted for simplification of description.

The user can select a folder, an image or the like on the management screen in FIG. 4 displayed on the screen of the LCD 4 by operating the joy stick 5b of the operation section 5 or touching the touch panel 32.

Next, display of the management screen described above and processes related to various functions will be described.

### (Operation)

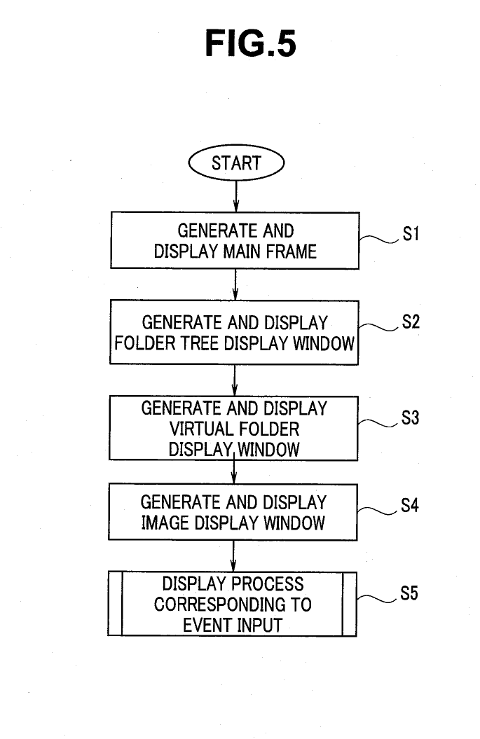

FIG. 5 is a flowchart showing an example of a flow of a management screen display process by the CPU 21 of the endoscope apparatus 1. A management screen display process program corresponding to the process in FIG. 5 is stored in the ROM 22.

When an instruction to display the management screen is issued from a predetermined menu screen by a predetermined operation on the operation section 5 of the endoscope apparatus 1 which is an endoscope image management apparatus, the CPU 21 reads out the management screen display process program from the ROM 22, develops the program in the RAM 23 and executes the program.

First, the CPU 21 generates a main frame for displaying multiple display areas of the management screen 51 and displays the main frame on the LCD 4 which is a display device (S1). As shown in FIG. 4, the CPU 21 generates a main frame 51a defining multiple display areas for displaying the three windows 52, 53 and 54 and displays the main frame 51a on the screen of the LCD 4 (S1). The main frame 51a includes three display areas for the three windows 52, 53 and 54.

Next, the CPU 21 generates the folder tree display window 52 and displays it in the main frame 51a (S2). In the case of the configuration of folders in FIG. 3, a folder tree structure as in FIG. 4 is displayed in the folder tree display window 52.

That is, the process of S2 constitutes a folder tree display processing section which displays a folder tree on the screen of the display device, the folder tree including multiple folders according to zones in which endoscope image files are registered, and multiple folders according to dates corresponding to time of registration of endoscope image files, which are higher-layer folders set as a hierarchical layer higher than the multiple folders according to zones. The folder tree shows a folder tree structure.

Then, the CPU 21 generates the virtual folder display window 53 and displays it in the main frame 51a (S3). As shown in FIG. 4, a display area for the virtual folder display window 53 is generated and displayed.

Then, the CPU 21 generates the image display window 54 and displays it in the main frame 51a (S4). As shown in FIG. 4, a display area for the image display window 54 is generated and displayed.

By the process from S1 to S4, a screen as shown in FIG. 4 is displayed in the main frame 51a as an initial display screen.

Then, when the user inputs various instructions in a state in which the management screen shown in FIG. 4 is displayed, the CPU 21 executes display processes corresponding to event inputs of the various instructions (S5). Next, the processes corresponding to the various event inputs will be described.

### (Event Inputs for Instructing Display of Virtual Folder and Instructing Display of Image Data)

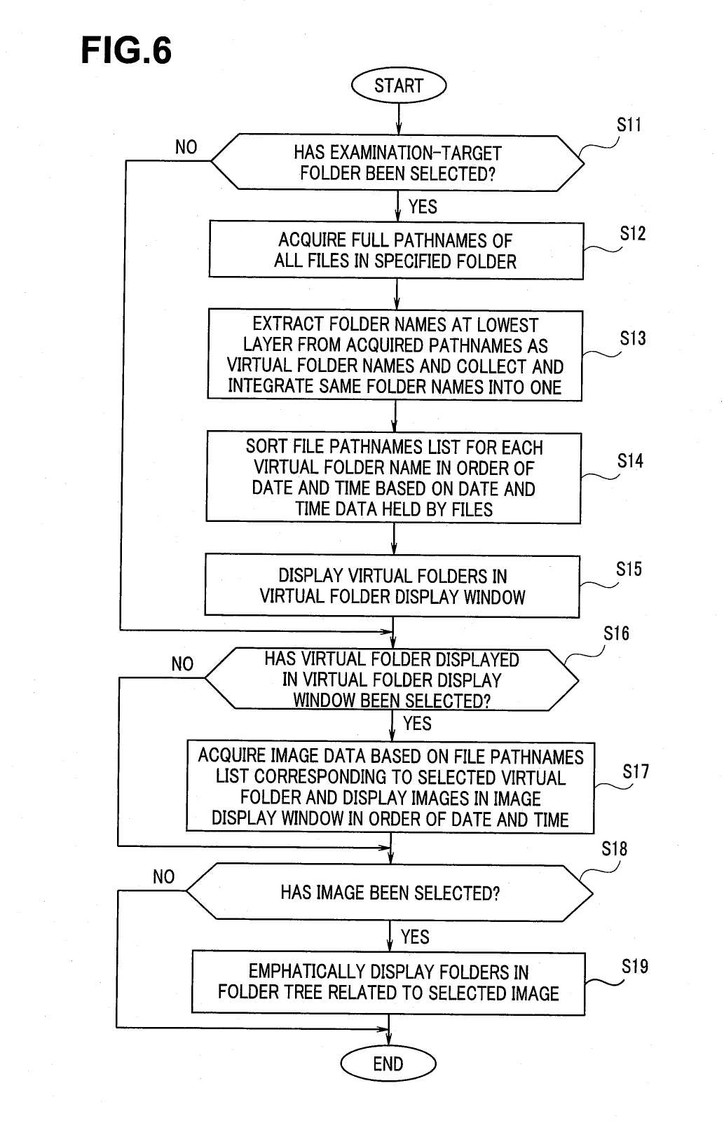

FIG. 6 is a flowchart showing an example of a flow of a process for displaying a virtual folder for a selected examination target and displaying image data for the selected virtual folder.

The CPU 21 judges whether or not an examination-target folder has been selected in the state in which the management screen in FIG. 4 is displayed (S11). On the management screen, whether an examination-target folder has been selected or not can be detected based on a position of a cursor displayed on the screen, which has been selected by the touch panel 32 or by the joy stick 5b.

When a certain examination-target folder has been selected (S11: YES), the CPU 21 acquires full pathnames of all files in the specified folder (S12).

When the folder “ENGINE1_SN001” has been selected, filenames of all image data included in folders at hierarchical layers lower than the folder “ENGINE1_SN001” are acquired in a form of full pathname.

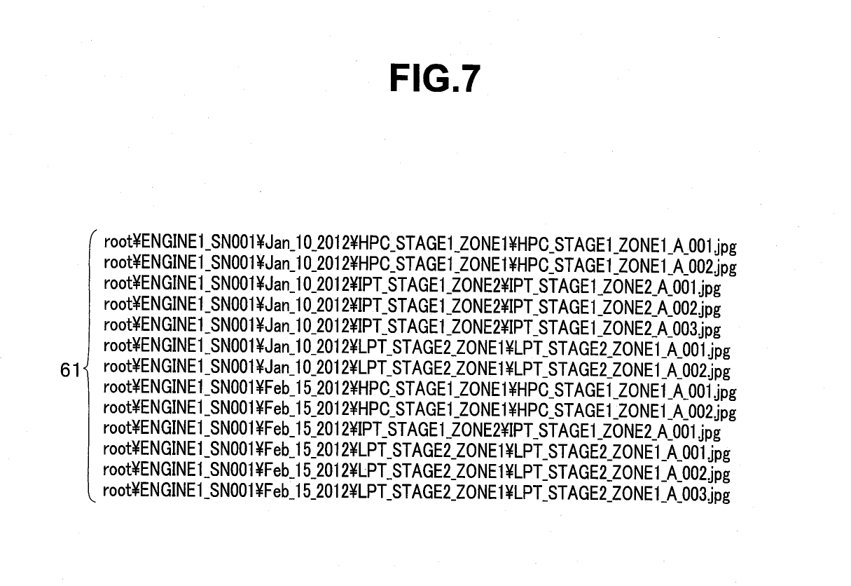

FIG. 7 shows an example of a list of full pathnames of all files of image data acquired when the folder “ENGINE1_SN001” is selected. A full pathnames list 61 in FIG. 7 includes data of multiple full pathnames, and a full pathname included in the list 61 is, for example, “root¥ENGINE1_SN001¥Jan_{—}10_{—}2012¥HPC_STAGE1_ZONE1øHPC_STAGE1_ZONE1_A_{—}001.jpg”.

Note that, here, “A” in “HPC-STAGE1_ZONE1_A_{—}001.jpg”, a part of the filename in the full pathname, is a mark indicating an examination result. That is, in the embodiment, a filename includes examination result information.

Next, the CPU 21 extracts folder names at the lowest layer from the acquired pathnames as virtual folder names, and collects and integrates the same folder names into one (S13). In the case of the folder “ENGINE1_SN001” shown in FIGS. 3 and 7, the folder names at the lowest layer are “HPC_STAGE1_ZONE1”, “IPT_STAGE1_ZONE2” and “LPT_STAGE2_ZONE1”.

Then, the CPU 21 sorts a file pathnames list for each virtual folder name in order of date and time based on date and time data held by files (S14).

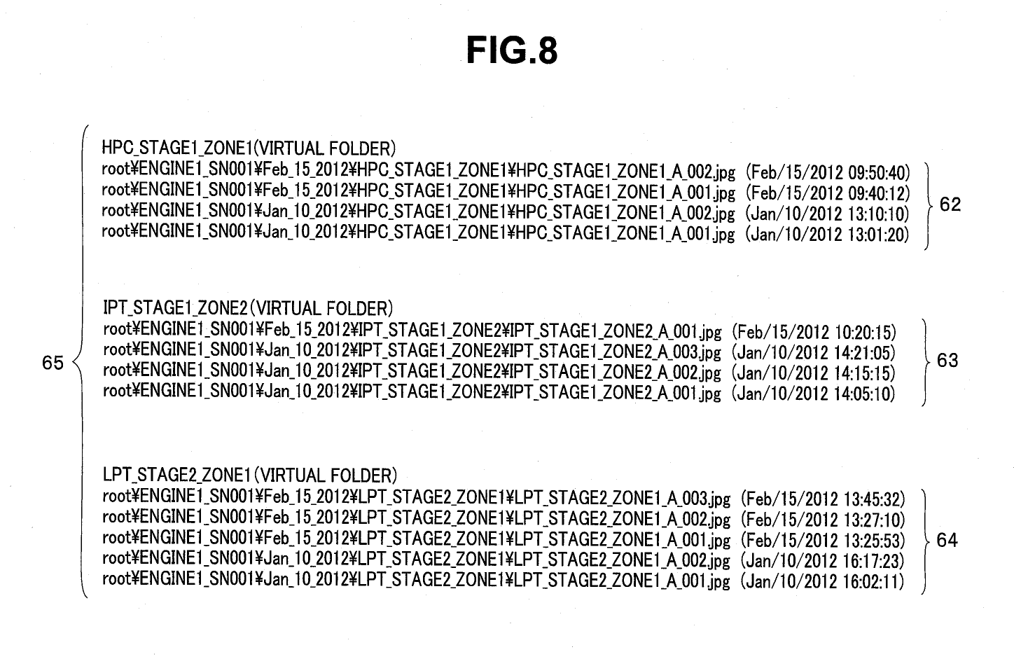

FIG. 8 is a diagram for illustrating a list of file pathnames for each virtual folder name, the file pathnames being sorted in order of date. FIG. 8 shows an all file pathnames list 65 which includes file pathnames lists 62, 63 and 64 for respective virtual folders of the folder “ENGINE1_SN001”.

The file pathnames list 62 is a list of file pathnames of the folder according to zone “HPC_STAGE1_ZONE1”, and the file pathnames are sorted in order of date and time. The file pathnames list 63 of the folder according to zone “IPT_STAGE1_ZONE2” and the file pathnames list 64 of the folder according to zone “LPT_STAGE2_ZONE1” are also sorted in order of date and time similarly.

Next, the CPU 21 displays the virtual folders in the virtual folder display window 53 (S15).

Note that, though the folder names of folders at the lowest layer are extracted as virtual folder names at S13, the virtual folder names extracted at S13 may be not the folder names of folders at the lowest layer but folder names of folders under respective higher folders which exist at an intermediate hierarchical layer between the folders at the lowest layer and the higher folders.

For example, there may be a case where an endoscope image file is included in a folder at an intermediate hierarchical layer higher than a lowest folder. In such a case, it is sometimes preferable to extract a folder name of the folder at the hierarchical layer higher than the lowest folder but lower than the highest folder, which includes such an endoscope image file, as a virtual folder name.

In such a case, the virtual folder name extraction process at S13 is caused to be a process for judging whether or not a folder lower than the highest folder includes an endoscope image file, and, if the folder lower than the highest folder includes an endoscope image file, extracting a folder name of the lower folder as a folder name of a virtual folder.

If the virtual folder name extraction process is caused to be such a process, a folder name of a virtual folder is a folder name of a folder at the lowest layer when an endoscope image file is not included in a folder at an intermediate hierarchical layer, and the folder name of the virtual folder is the folder name of the folder at the intermediate hierarchical layer when an endoscope image file is included in the folder at the intermediate hierarchical layer.

That is, a virtual folder is a folder at the lowest layer included in each highest folder or a folder at an intermediate hierarchical layer existing between the folder at the lowest layer included in each highest folder and the highest folder.

As described above, the process from S12 to S14 constitutes a virtual folder generating section which extracts, based on folder names of multiple folders according to zones, the folder names of the lower folders which include at least one endoscope image file, as virtual folder names, the lower folders being included in each of folders according to dates, which are multiple higher folders; collects and integrates the same folder names into one; and associates endoscope image files included in folders according to zones having the same folder name with the extracted virtual folder. The process of S15 constitutes a virtual folder display processing section which displays the extracted virtual folder on the screen.

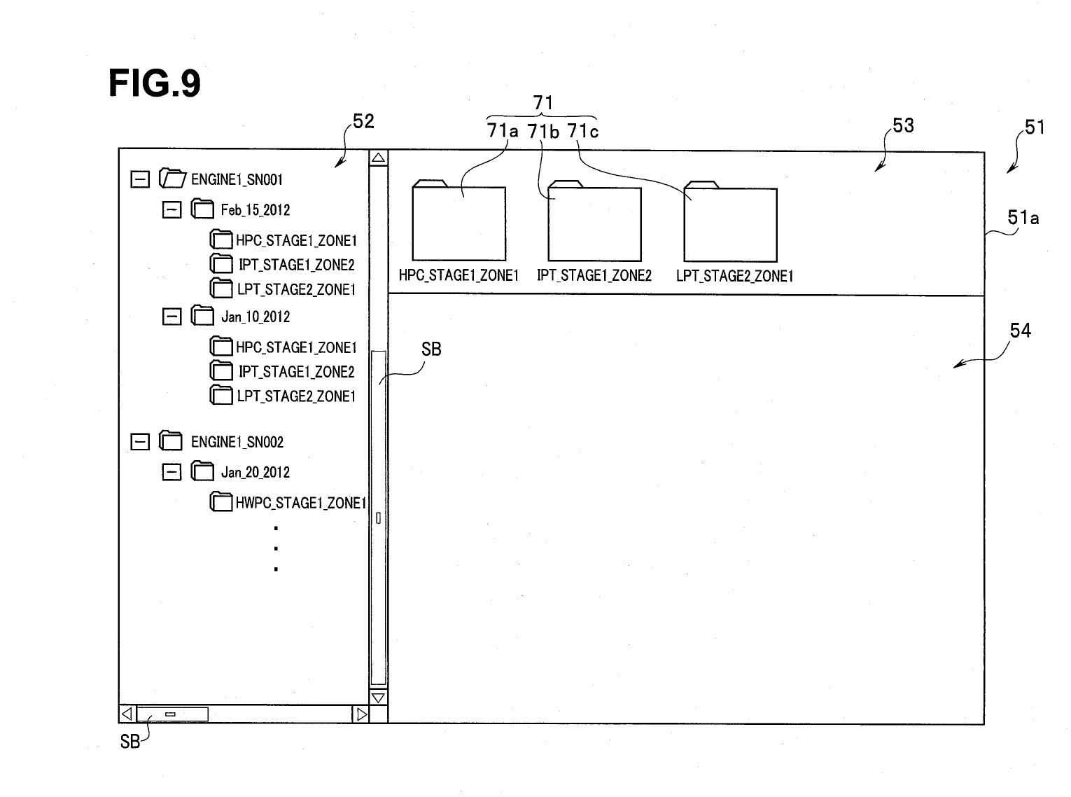

FIG. 9 is a diagram showing a display example of the management screen when an examination-target folder is selected.

When the examination-target folder “ENGINE1_SN001” is selected, three virtual folders 71a, 71b and 71c are displayed on the virtual folder display window 53 as shown in FIG. 9. Folder names of the three virtual folders 71a, 71b and 71c (hereinafter referred to as a virtual folder 71 when the three virtual folders or any one of the three virtual folders is referred to) are “HPC_STAGE1_ZONE1”, “IPT_STAGE1_ZONE2” and “LPT_STAGE2_ZONE1”, which are folder names at an immediately higher hierarchical layer of respective files. That is, in the virtual folder display window 53, folder names of folders according to zones having the same name at a higher hierarchical layer, in file pathnames included in a file pathnames list are displayed as virtual folder names.

If an examination-target folder is not selected (S11: NO) or after the process of S15, the CPU 21 judges whether any of the multiple (here, three) virtual folders displayed in the virtual folder display window 53 has been selected or not (S16). Here also, whether a virtual folder has been selected or not can be detected by the touch panel 32 or the like.

If any one of the multiple virtual folders is selected (S16: YES), the CPU 21 acquires image data based on a file pathnames list (FIG. 8) corresponding to the selected virtual folder and displays images in the image display window 54 in order of date and time (S17).

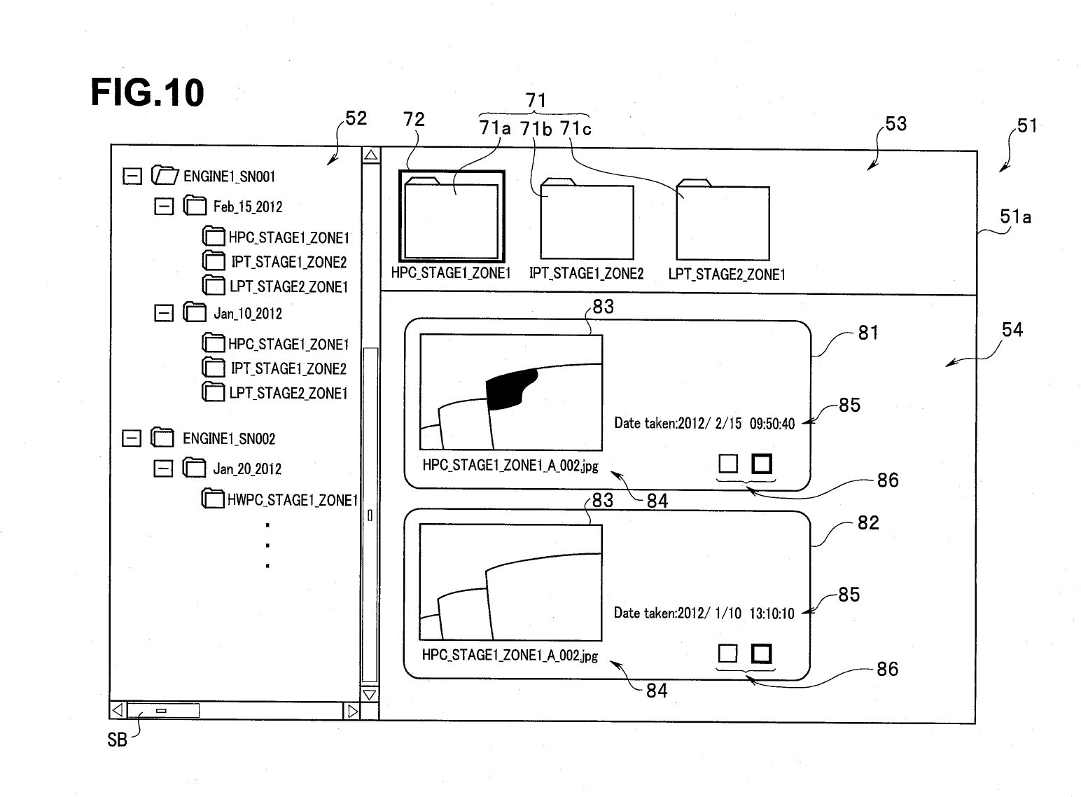

FIG. 10 is a diagram showing a display example of the management screen when a certain virtual folder has been selected. In FIG. 10, it is shown that the virtual folder 71a has been selected by a thick frame 72 being added to the virtual folder 71a and displayed.

As shown in FIG. 10, multiple (here, two) images are displayed on the image display window 54.

In the image display window 54, it is shown that image data corresponding to two days exists, by two small windows 81 and 82. The small window 81 is a window for image data of Feb. 15, 2012, and the small window 82 is a window for image data of Jan. 10, 2012.

Each small window includes an image display area 83 for displaying an endoscope image, a filename display area 84 for displaying a filename, an image pickup date and time display area 85 for displaying a date and time of picking up the image, and an order position display area 86 for showing a position of the image displayed in the image display area 83 in the order of multiple images.

If multiple images exists for the same zone, the number of marks (in FIG. 10, square marks) corresponding to the number of the images are displayed side by side in the order position display area 86. Which image data among the multiple images the mark for an image displayed in the image display area 83 corresponds to is indicated by a thick frame. Since two square marks are displayed in FIG. 10, it is shown that there are two images. Each mark corresponds to image data, and it is shown that an image corresponding to a mark displayed thick (a square mark on the right side in FIG. 10) is displayed in the image display area 83.

A filename displayed in the filename display area 84 and an image pickup date and time displayed in the image pickup date and time display area 85 are also information about the filename and image pickup date and time of the image displayed in the image display area 83.

When a thin square mark is selected (that is, when the mark is touched on the screen), the thin mark is changed and displayed thick, and the square mark which has been displayed thick becomes thin. An image corresponding to the mark changed and displayed thick is displayed in the image display area 83. The information displayed in the filename display area 84 and the image pickup date and time display area 85 is also changed to information about the changed image.

As described above, the process of S17 constitutes an image display processing section which, when a virtual folder displayed on the screen of the LCD 4 is selected, displays endoscope images of one or more endoscope image files associated with the selected virtual folder, on the screen.

Furthermore, when the virtual folder displayed in the virtual folder display window 53 is not selected (S16: NO) or after the process of S17, it is judged whether or not an image has been selected from images displayed in the image display window 54 (S18). Whether or not an image has been selected can be detected by the touch panel 32 or the like.

When an image is selected (S18: YES), folders in a folder tree related to the selected image are displayed being emphasized in comparison with other folders (S19).

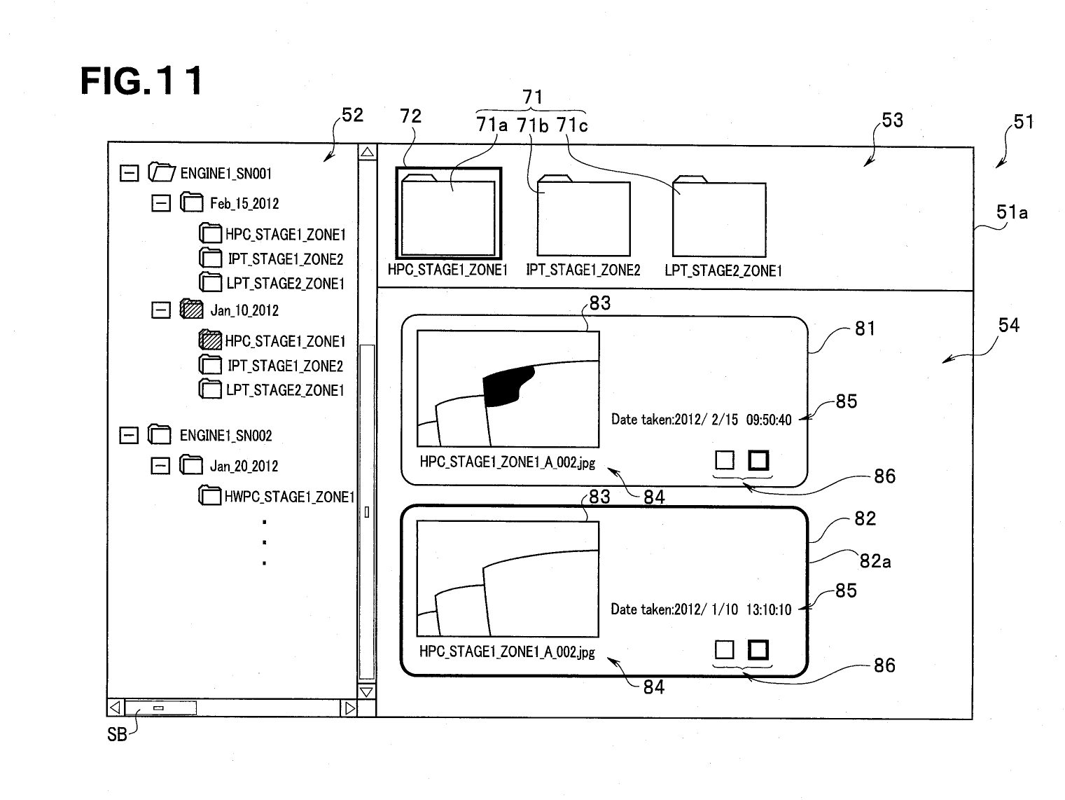

FIG. 11 is a diagram showing a display example of a sample image in the management screen when a certain image is selected. In FIG. 11, it is shown that an image in the small window 82 is selected by a thick frame 82a being added to the small window 82 (in FIG. 11, an image picked up on Jan. 10, 2012) and displayed.

Then, as shown in FIG. 11, icons of the higher two folders “Jan_{—}10_{—}2012” and “HPC_STAGE1_ZONE1” which are related to the selected image are displayed being emphasized in comparison with other icons in the folder tree display window 52. Though it is indicated by oblique lines that the icons are displayed being emphasized in FIG. 11, the emphasized display may be performed, for example, by changing the colors of the icons.

That is, the process of S19 constitutes a folder identifiably displaying section which, when an endoscope image displayed on the screen of the LCD 4 is selected, identifiably displays a folder according to zone in which the selected endo scope image is registered and a folder according to date which is a higher folder at a hierarchical layer higher than the folder according to zone in which the endoscope image is registered in a folder tree.

If an image is not selected (S18: NO) or after the process of S19, the process ends.

As described above, when an event input to instruct display of virtual folders occurs, the endoscope apparatus 1 displays folders according to zones common to folders according to dates of the selected examination target as virtual folders in the virtual folder display window 53 on the management screen on the screen of the LCD 4. Then, when one virtual folder is selected from the group of virtual folders displayed in the virtual folder display window 53, the CPU 21 of the endoscope apparatus 1 displays images associated with the selected virtual folder in the image display window 54.

Furthermore, when an image is selected from the group of images displayed in the image display window 54, icons of related folders are displayed being emphasized in the folder tree display window 52. Therefore, the user can easily grasp which folder the selected image is registered with, in other words, about which zone on what date the selected image is.

As described above, according to the endoscope apparatus described above, the user can easily compare images of the same zone picked up and obtained on different days without performing a troublesome file selection operation as done conventionally and can confirm change in an examination target over time from the endoscope images.

Therefore, for confirming change in an examination target over time from endoscope images, the user can easily confirm the change in the examination target over time without performing a troublesome folder selection operation.

### Another Embodiment

There may be a case where image data is registered with each of multiple folders according to zones at a layer lower than each of folders according to dates. However, there may be also a case where all folders do not exist at a hierarchical layer lower than a folder according to date, and a case where there is a folder according to zone in which image data is not registered. Another embodiment relates to a display process for coping with such a case to perform appropriate display.

Note that, since configuration of an endoscope apparatus 1 in the other embodiment is similar to the configuration of the embodiment shown in FIGS. 1 and 2 described above, description thereof will be omitted, and only different points will be described.

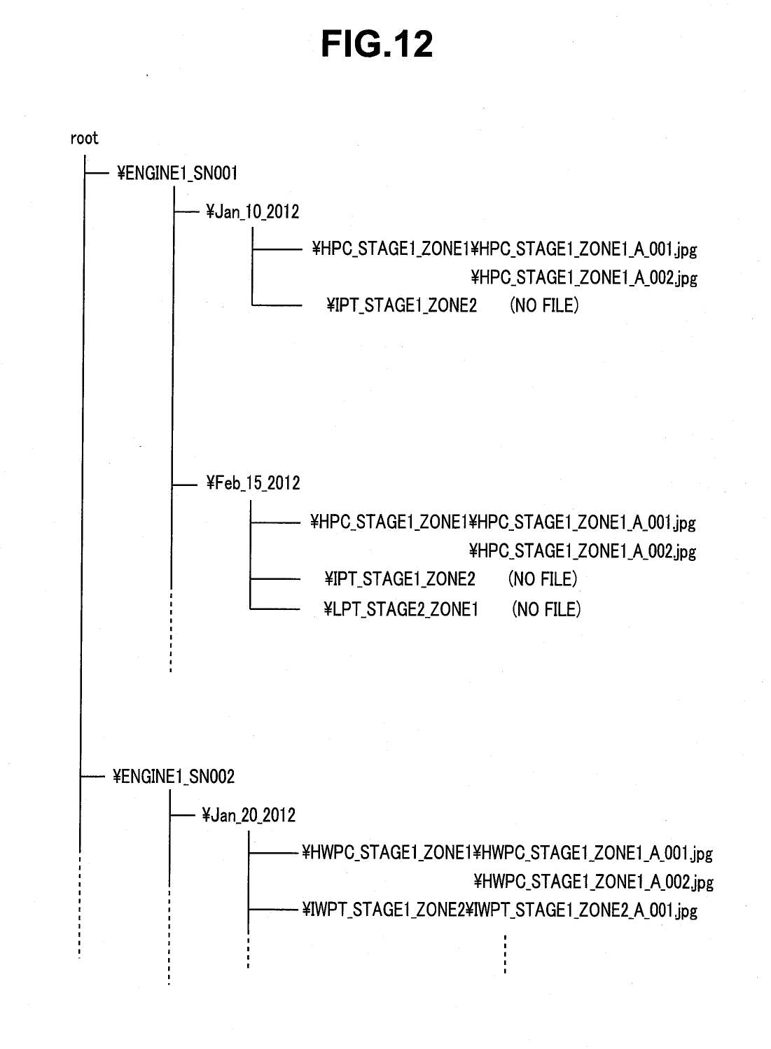

FIG. 12 is a diagram for illustrating an example of folders in a hierarchical structure according to the other embodiment. In the case of the group of folders in FIG. 12, the examination-target folder “ENGINE1_SN001” includes the folders according to dates “Jan_{—}10_{—}2012” and “Feb_{—}15_{—}2012”.

However, the folder “Jan_{—}10_{—}2012” includes only two folders according to zones, and the folder “Feb_{—}15_{—}2012” includes three folders according to zones as described above. Furthermore, image data is not registered with the folder “IPT_STAGE1_ZONE2” in the folder “Jan_{—}10_{—}2012”, and, similarly, image data is not registered with the folders “IPT_STAGE1_ZONE2” and “LPT_STAGE2_ZONE1” in the folder “Feb_{—}15_{—}2012”.

The reason why a folder which should originally exist does not exist is, for example, that the user has deleted the folder by mistake. The reason why a file is not registered with a folder is, for example, that examination has not been performed yet.

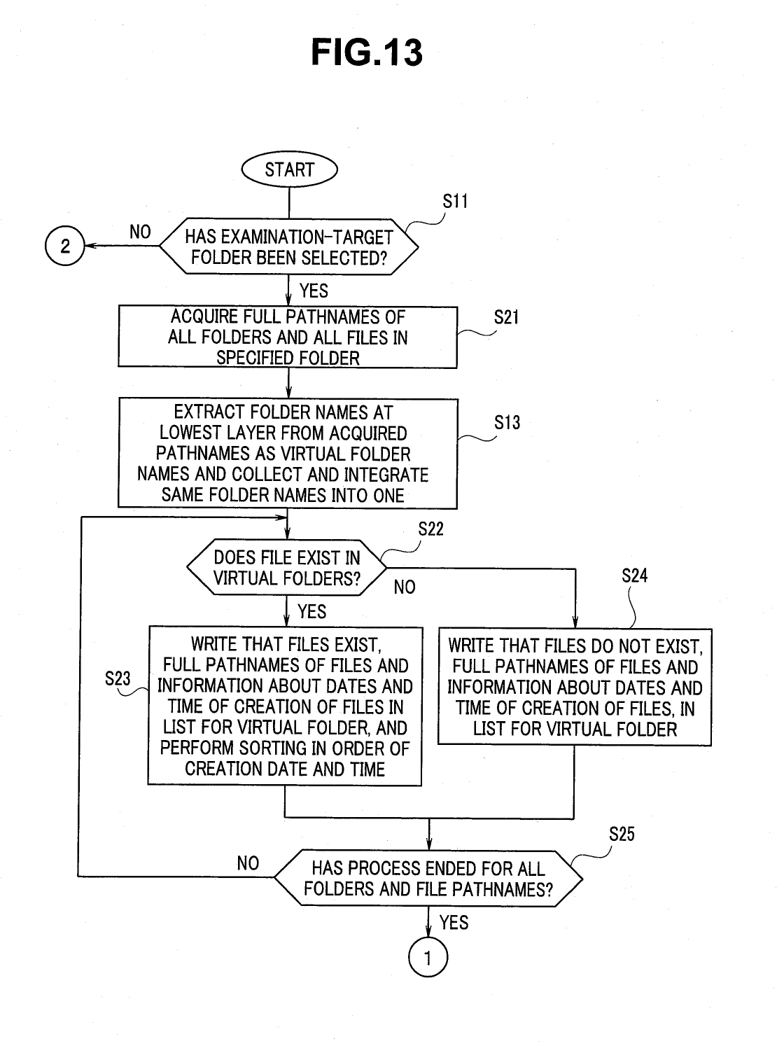

The other embodiment can cause the user to easily know existence/nonexistence of a folder and existence/nonexistence of a file under such a configuration of folders and such a file registration situation. In the other embodiment also, the process in FIG. 5 is performed and the process in FIG. 13 is executed instead of the process in FIG. 6.

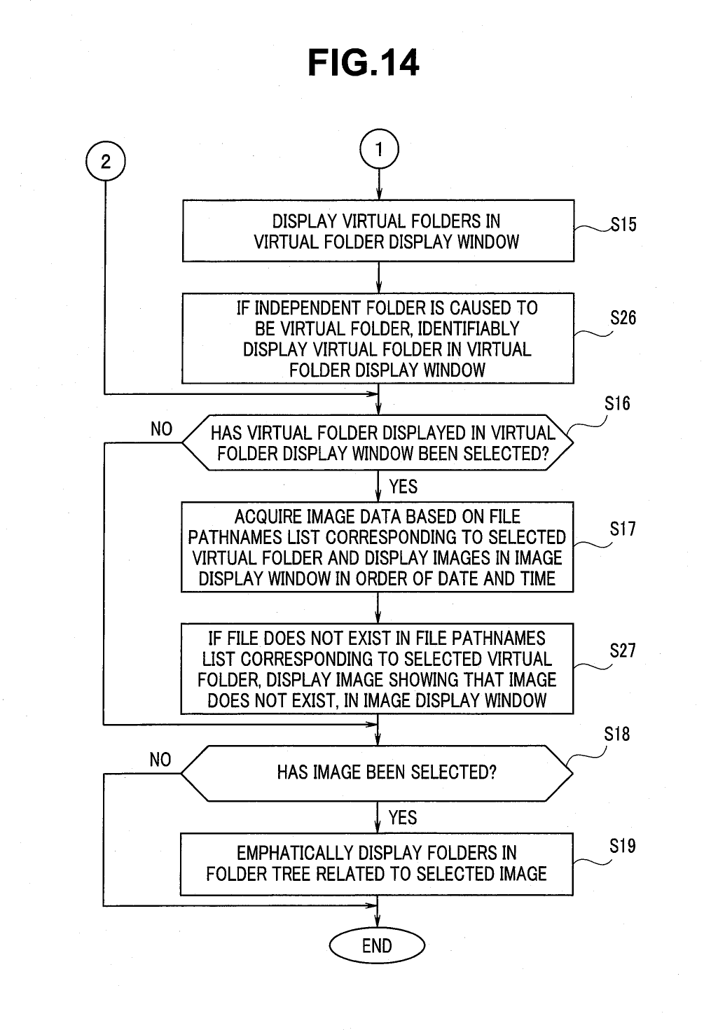

FIGS. 13 and 14 are flowcharts showing an example of a flow of a process for displaying a virtual folder for a selected examination target and displaying image data for the selected virtual folder.

In FIGS. 13 and 14, the same processes as those in FIG. 6 are given the same reference numerals, and description thereof will be omitted. Processes different from those in FIG. 6 will be described.

When a certain examination-target folder has been selected (S11: YES), the CPU 21 acquires full pathnames of all folders and all files in the specified folder (S21).

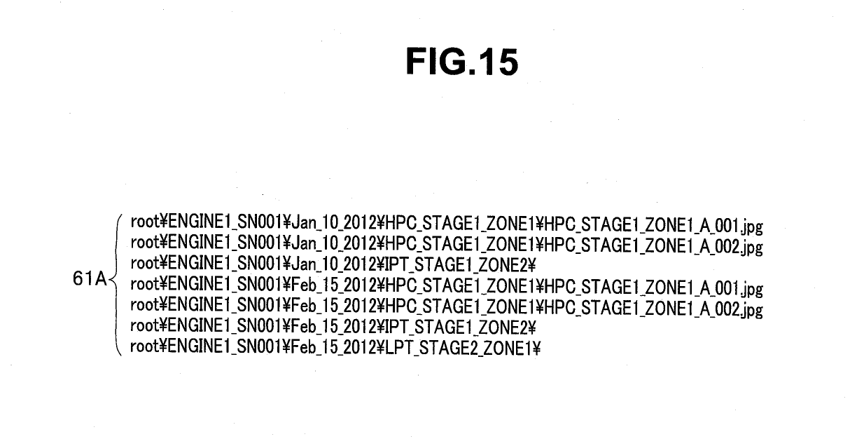

FIG. 15 shows an example of a list of full pathnames of all folders and all files of image data acquired when the folder “ENGINE1_SN001” is selected. As shown in FIG. 15, such full pathnames of folders which do not include a file are also included in a list 61A. In the list 61A, “root¥ENGINE1_SN001¥Jan_{—}10_{—}2012¥IPT_STAGE1_ZONE2¥”, “root¥ENGINE1_SN001¥Feb_{—}15_{—}2012¥IPT_STAGE1_ZONE2¥” and “root¥ENGINE1_SN001¥Feb_{—}15_{—}2012¥LPT_STAGE2_ZONE1¥” are full pathnames of folders which do not include a file.

When the CPU 21 executes the process of S13, the folders “HPC_STAGE1_ZONE1”, “IPT_STAGE1_ZONE2” and “LPT_STAGE2_ZONE1” are extracted as virtual folder names.

After the process of S13, the CPU 21 judges whether a file exists in the virtual folders (S22).

If files exist in the virtual folders (S22: YES), the CPU 21 writes that the files exist, full pathnames of the files and information about dates and time of creation of the files in a list for virtual folder, and performs sorting in order of the creation date and time (S23).

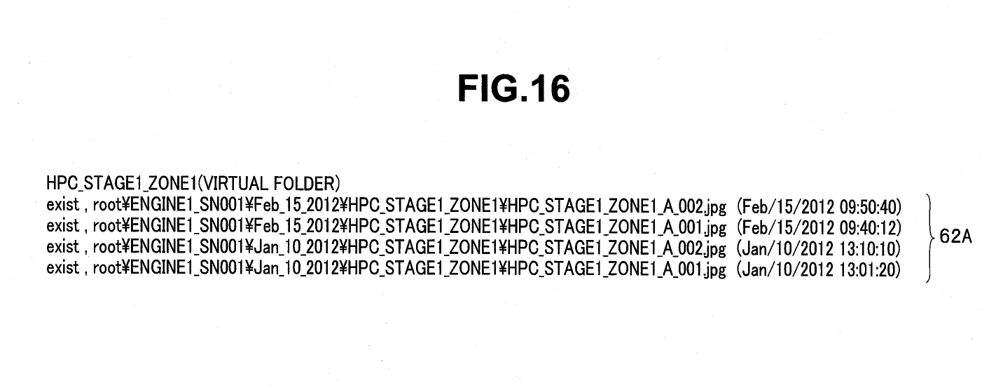

FIG. 16 is a diagram for illustrating a list of file pathnames for each virtual folder name, the file pathnames being sorted in order of date. As shown in FIG. 12, the folders “IPT_STAGE1_ZONE2” and “LPT_STAGE2_ZONE1” which are at a layer lower than the folder “ENGINE1_SN001” do not include a file. Therefore, as shown in FIG. 16, an all file pathnames list includes only the file pathnames list 62A of the folder “HPC_STAGE1_ZONE1”. As shown in FIG. 16, the list for virtual folder includes information about existence of file (exist), file paths and creation dates and time of the files. If files do not exist in the list for virtual folder (S22: NO), the CPU 21 writes that the files do not exist, full pathnames of the files and information about dates and times of creation of the files, in the list for virtual folder, and performs sorting in order of date and time based on the creation date and time data (S24).

The process of S24 is a process executed in a case like the case of the folder “IPT_STAGE1_ZONE2”. That is, though the two folders according to dates “Jan_{—}10_{—}2012” and “Feb_{—}15_{—}2012” include the folder “IPT_STAGE1_ZONE2”, a file is registered with neither of the folders. Therefore, the CPU 21 writes that files do not exist in a list for virtual folders having the same name, folder paths and information about folder creation dates and time, in the list for virtual folders having the same name, and performs sorting in order of date and time based on the creation date and time data.

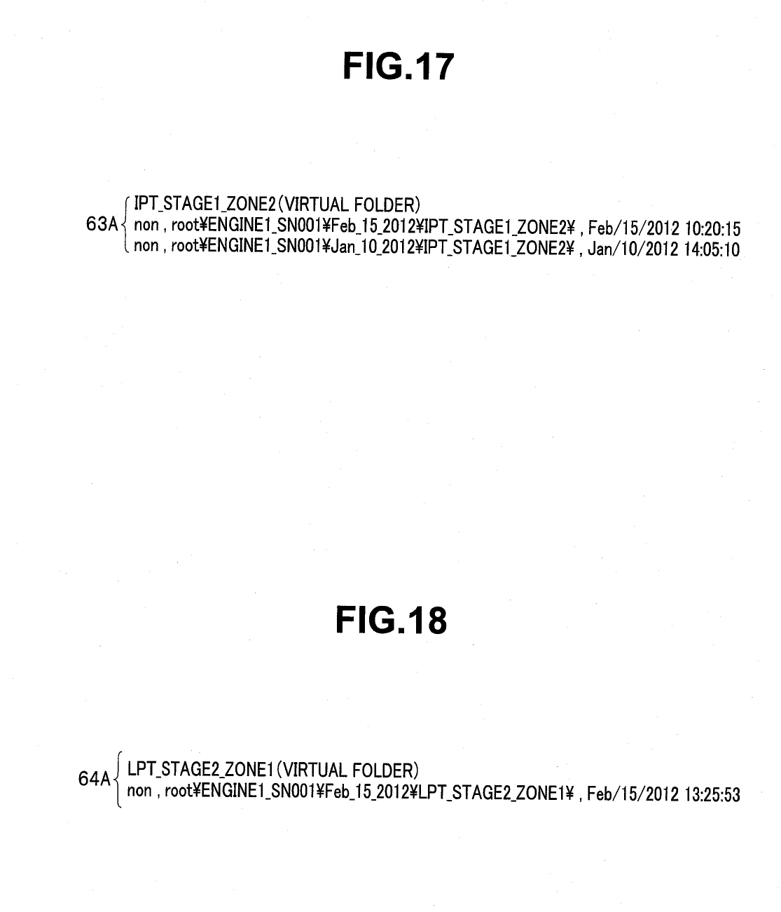

FIGS. 17 and 18 are diagrams showing an example of a list which includes information about nonexistence of files, folder paths and folder creation dates and times as a list for virtual folders having the same name. As shown in FIGS. 17 and 18, the list for virtual folders having the same name includes information about nonexistence of files (non), file paths and creation dates and times of the folders.

Next, after the processes of S23 and S24, the CPU 21 judges whether the above process has ended for all folders and file pathnames (S25). If the above process has not ended for all the folders and file pathnames (S25: NO), the process returns to S22. If the above process has ended for all the folders and file pathnames (S25: YES), the process transitions to S15.

Next, the CPU 21 displays the virtual folders in the virtual folder display window as shown in FIG. 9 (S15).

Then, if such an independent folder that no other folder having the same name exists is caused to be a virtual folder, the CPU 21 identifiably displays the virtual folder in the virtual folder display window 53 (S26).

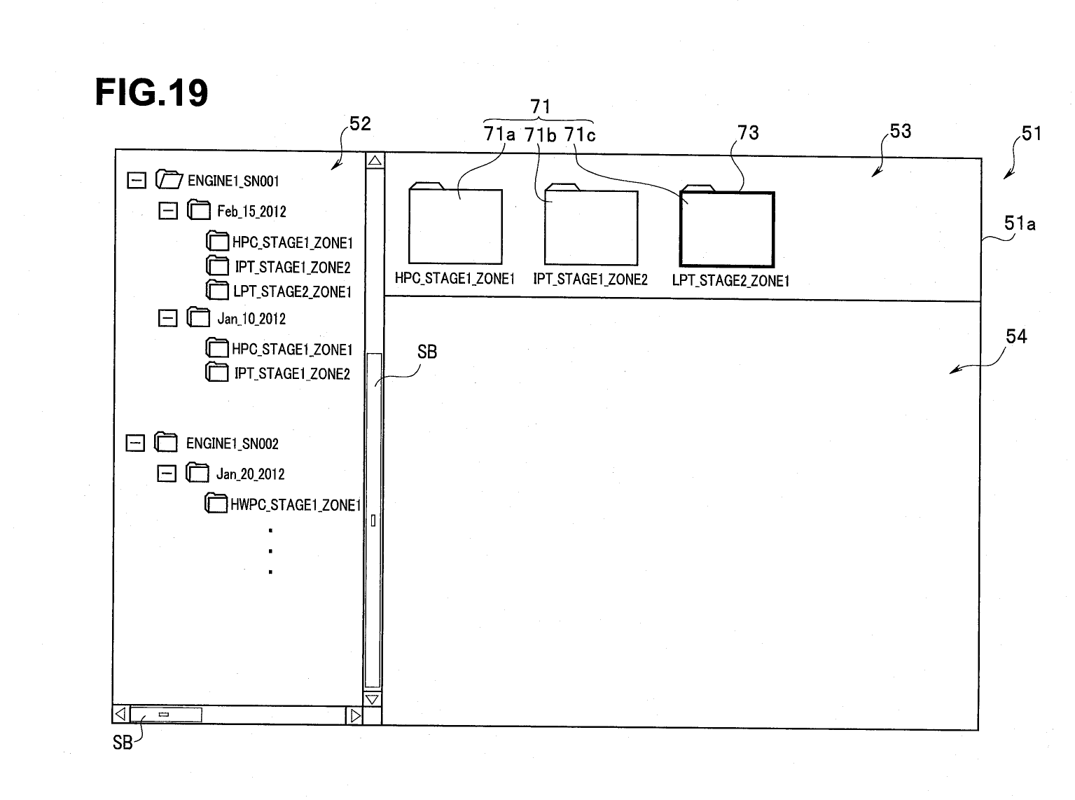

FIG. 19 is a diagram showing a display example of the management screen when an independent folder is identifiably displayed. As shown in FIG. 19, an icon frame 73 for the virtual folder “LPT_STAGE2_ZONE1” is emphasized being thickened so that it can be distinguished from other virtual folders. Therefore, the user can recognize that the identifiably displayed virtual folder is an independent folder.

That is, the process of S26 constitutes a virtual folder display processing section which identifiably displays a virtual folder which is such an independent folder that no other folder having the same name exists under a folder higher than the virtual folder.

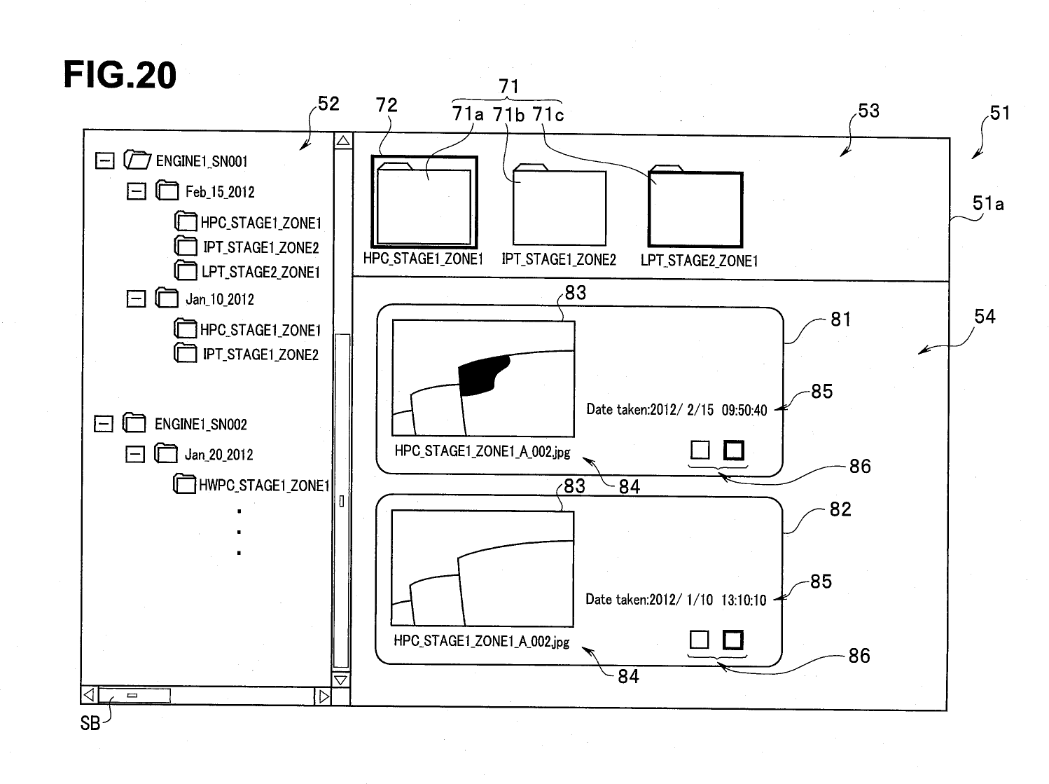

Furthermore, the CPU 21 judges whether any of virtual folders displayed in the virtual folder display window 53 has been selected or not (S16), and, if any one of the virtual folders is selected (S16: YES), displays images in order of date and time in the image display window 54 as shown in FIG. 20 (S17).

FIG. 20 is a diagram showing a display example of the management screen when a certain virtual folder is selected. In FIG. 20, it is shown that the virtual folder 71a has been selected by a thick frame 72 being added to the virtual folder 71a and displayed.

Then, if a file does not exist in a file pathnames list corresponding to the selected virtual folder, the CPU 21 displays an image showing that an image does not exist, in the image display window 54 (S27).

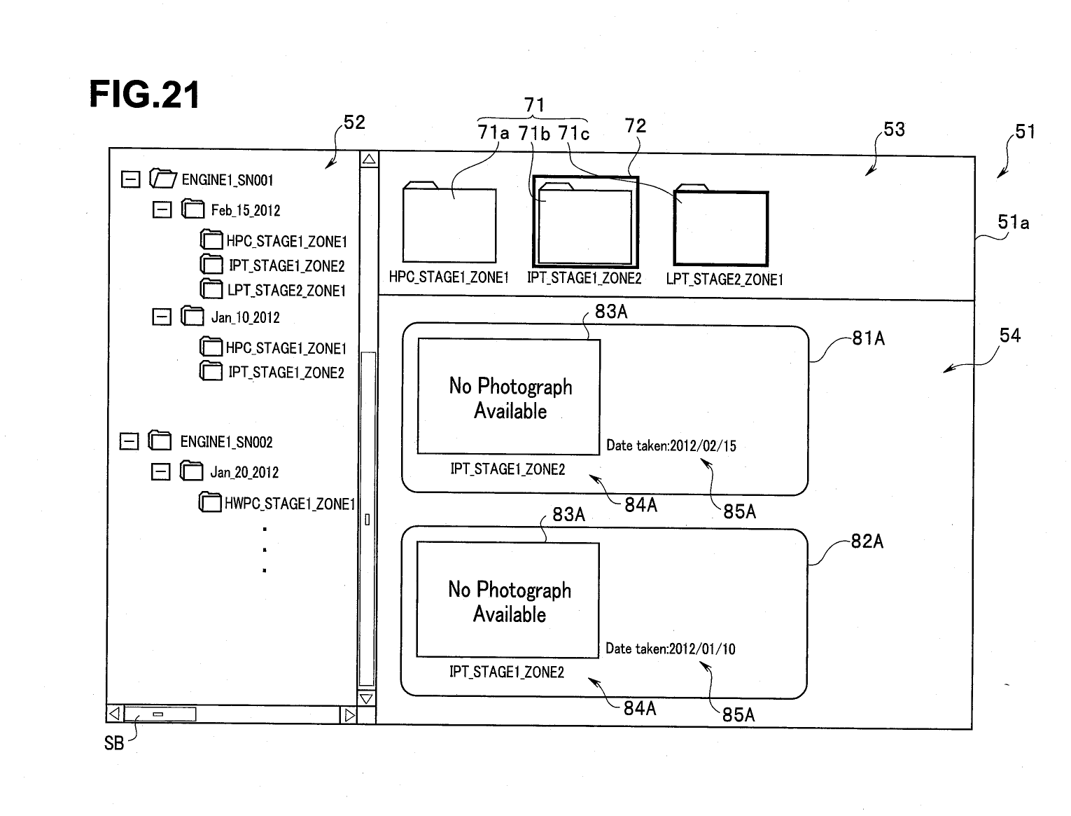

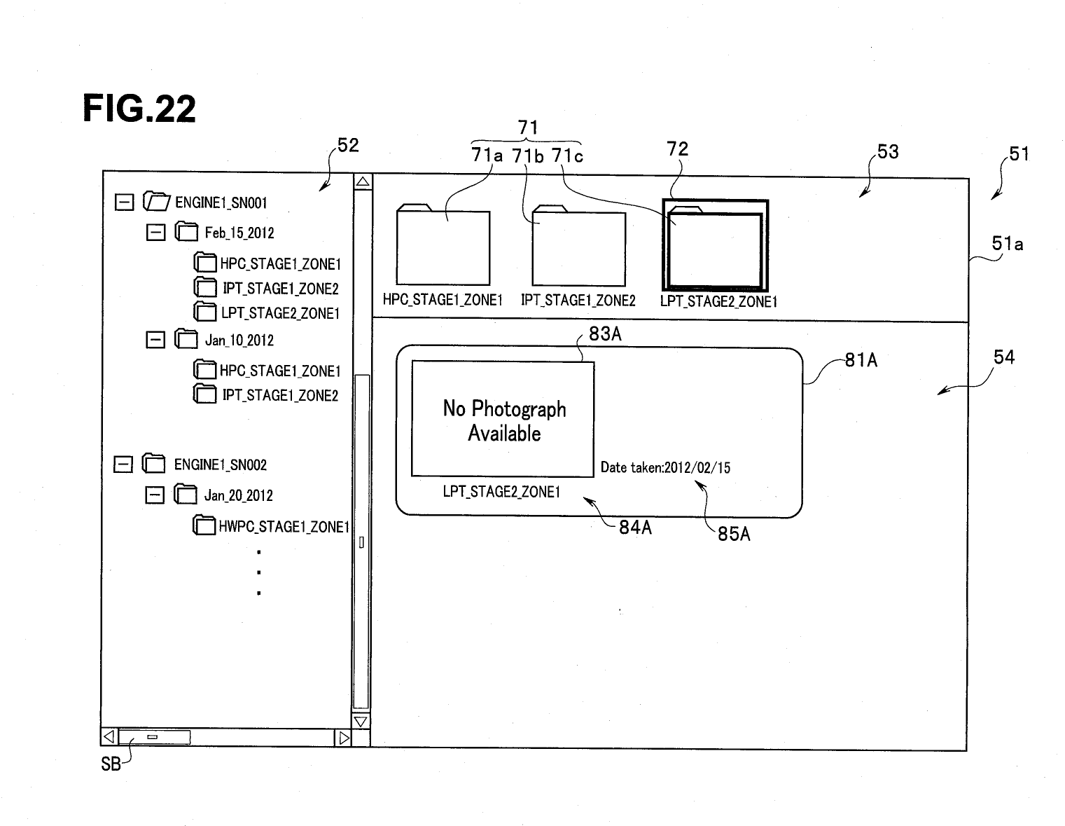

FIGS. 21 and 22 are diagrams showing a display example of the management screen in the case where a file does not exist in a file pathnames list corresponding to a selected virtual folder. In FIGS. 21 and 22, a thick frame 72 is displayed being added to a selected virtual folder. FIG. 21 is a diagram showing a display example of the management screen in the case where the virtual folder “IPT_STAGE1_ZONE2” is selected. FIG. 22 is a diagram showing a display example of the management screen in the case where the virtual folder “LPT_STAGE2_ZONE1” is selected.

As shown in FIGS. 21 and 22, a small window 81A is displayed in the image display window 54, and the small window 81A includes an image display area 83A for displaying a message image (an image of “No Photograph Available”) showing that a file does not exist, that is, there is not an image, a folder name display area 84A for displaying a folder name, and a creation date and time display area 85A for displaying a date and time of creation of a folder.

Therefore, the user can easily grasp which folder does not include image data. The process of S27 constitutes a predetermined image displaying section which, if a virtual folder displayed on the screen is selected and an endoscope image file is not registered with the selected virtual folder, displays a predetermined image showing that the endoscope image file does not exist, on the screen of the LCD 4.

After that, the CPU 21 executes processes of S18 and S19.

As described above, according to the endoscope apparatus described above, it is possible to easily recognize existence of a folder which does not include a file and nonexistence of a folder, in addition to advantages similar to those of the endoscope apparatus of the embodiment. Thus, the user can not only easily recognize an unexamined zone or failure in examination from nonexistence of a file but also easily recognize a possibility of wrong deletion of a folder or the like from nonexistence of a folder.

As described above, according to the endoscope apparatuses of the embodiments described above, it is possible to realize an endoscope image management apparatus and endoscope image display method making it easy to confirm change in an examination zone over time.

### (Modification)

In the endoscope apparatuses of the embodiments described above, the user confirms change in an examination zone by seeing endoscope images. An endoscope apparatus of the present modification can cause the user to easily know what change has occurred, based on examination result data.

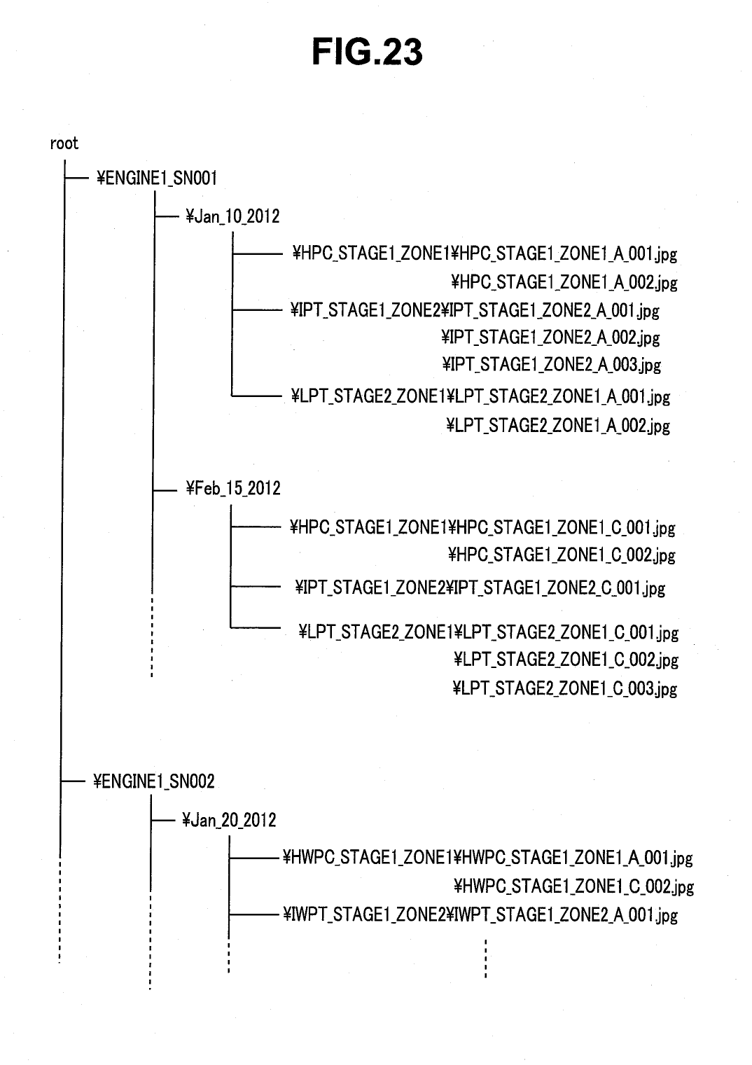

FIG. 23 is a diagram for illustrating an example of folders in a hierarchical structure according to the present modification. Similarly to FIG. 3, FIG. 23 also schematically expresses each folder and files included in the folder to explain the folders with a hierarchical structure. Here, an example is shown in which a folder has three hierarchical layers, that is, three levels.

FIG. 23 is different from FIG. 3 in that examination result information about an image is different. An examination result mark in a filename of an image included in each of folders according to zones under the folder according to date “Feb_{—}15_{—}2012” is different from an examination result mark in a filename of an image included in each of folders according to zones under the folder according to date “Jan_{—}10_{—}2012”.

Here, it is assumed that, for example, an examination result mark “A” means “nonexistence of abnormality”, and a mark “C” means that an image does not indicate “nonexistence of abnormality” but indicates, for example, “existence of abnormality”.

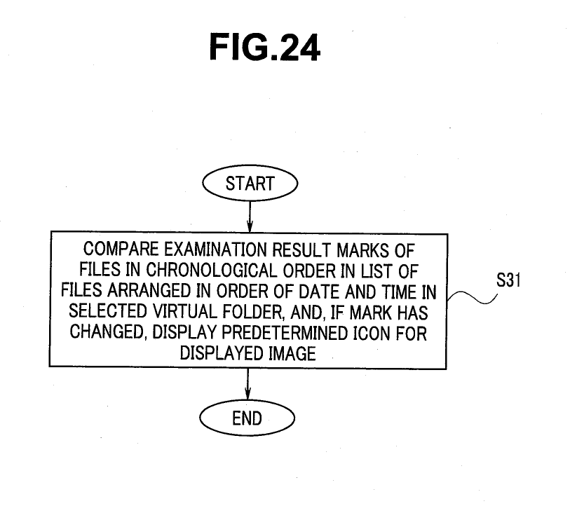

FIG. 24 is a flowchart showing an example of a flow of a process executed when a virtual folder is selected in a state in which the management screen is displayed.

The flowchart in FIG. 24 is executed together with or after the process of S17 in FIGS. 6 and 4.

As shown in FIG. 24, when a virtual folder is selected, the CPU 21 displays images in order of date and time in the image display window 54, compares examination result marks of files in chronological order in a list of files arranged in order of date and time in the selected virtual folder, and, if a mark has changed, displays a predetermined icon for a displayed image (S31). To compare examination result marks of files in chronological order means to judge whether an examination result mark of each file and an examination result mark of a file which is temporally before after the file are the same or not by comparison.

For example, in a folder “¥ENGINE1_SN002¥Jan_{—}20_{—}2012¥HWPC_STAGE1_ZONE1” in FIG. 23, two folders having different judgment results, “HWPC_STAGE1_ZONE1_A_{—}001.jpg” and “HWPC_STAGE1_ZONE1_C_{—}002.jpg”, exist. In this case, the result C indicating existence of abnormality may be set as a representative result of the folder.

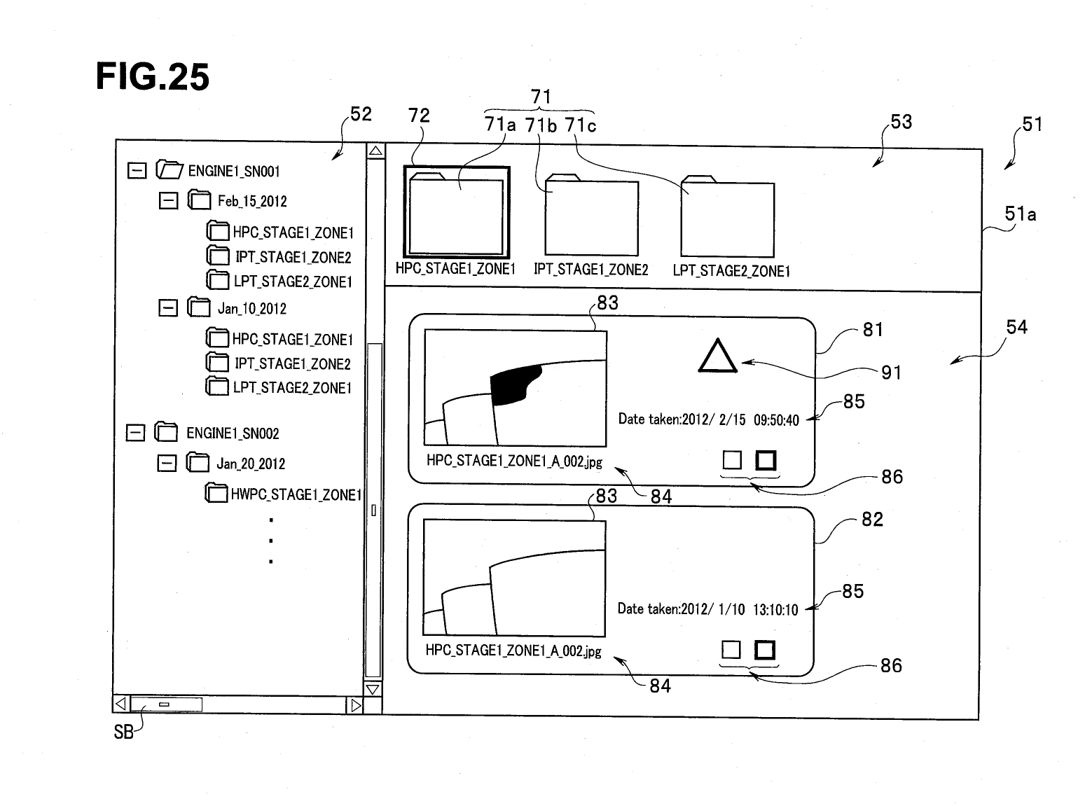

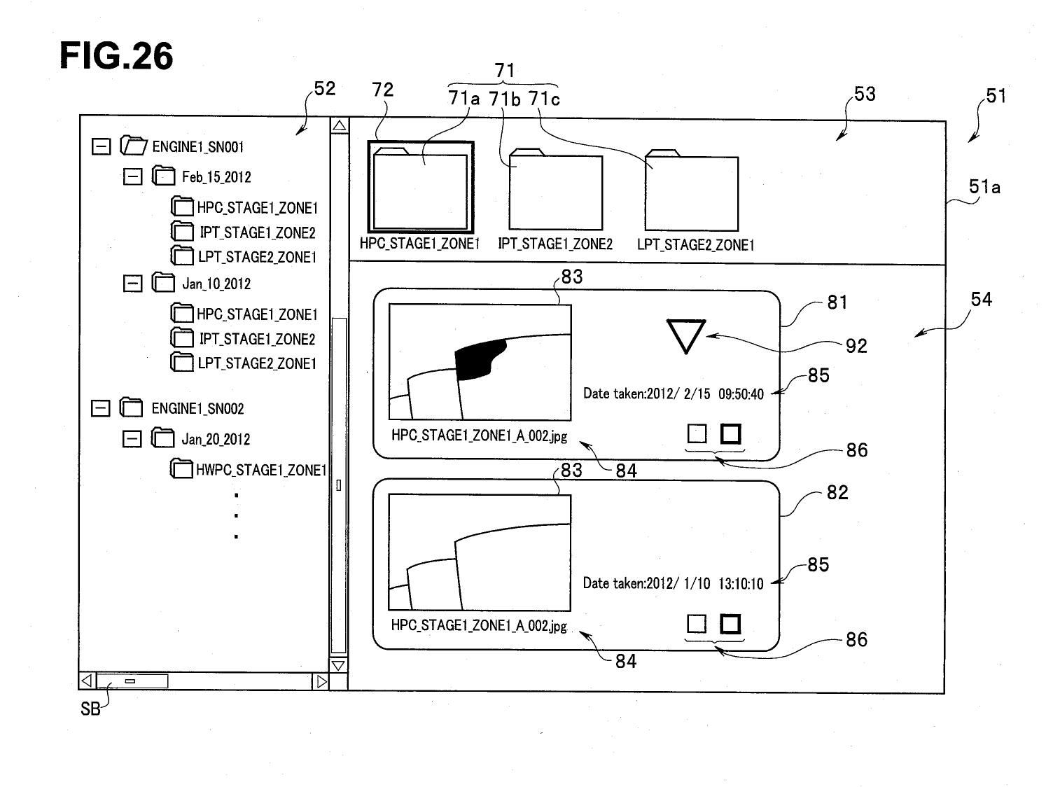

FIGS. 25 and 26 are diagrams showing a display example of the management screen when an examination result mark has changed.

FIG. 25 is a display example of the management screen in the case where an image changes from “nonexistence of abnormality” to “existence of abnormality”. In FIG. 25, a mark 91 associated with an image is a mark shown when the image has changed from “nonexistence of abnormality” to “existence of abnormality”.

FIG. 26 is a display example of the management screen in the case where an image changes from “existence of abnormality” to “nonexistence of abnormality”. In FIG. 26, a mark 92 associated with an image is a mark shown when the image has changed from “existence of abnormality” to “nonexistence of abnormality”.

That is, the process of S31 constitutes an image display processing section which, if result information about an endoscope image displayed on the screen is different from result information about an endoscope image before or after a time of registration of the endoscope image, displays a predetermined mark, associating the mark with the endoscope image displayed on the image.

Thus, the user can easily grasp since when a state has changed by seeing the management screen shown in FIGS. 25 and 26.

As described above, according to the endoscope apparatuses of each of the embodiments and modification described above, it is possible to realize an endoscope image management apparatus and endoscope image display method making it possible to easily confirm change in an examination target over time.

Note that, though the endoscope apparatus performs the management screen display process as an endoscope image management apparatus in each of the embodiments and modification described above, the management screen display process described above may be performed on a PC. In that case, the PC is the endoscope image management apparatus.

For example, by transferring an endoscope image obtained by an endoscope apparatus to a PC and installing a program for executing the management screen display process described above on the PC, it is possible to perform a management screen display process similar to that of each of the embodiments and modification described above.

Each “section” in the present specification is a conceptual “section” corresponding to each function of the embodiments and does not necessarily correspond to hardware or a software routine one-to-one. Therefore, in the present specification, the embodiments have been described on the assumption of virtual circuit blocks (sections) having respective functions of the embodiments. Furthermore, the respective steps of each procedure in the embodiments may be executed in a changed execution order. A plurality of the steps may be executed at the same time. The steps may be executed in a different order each time they are executed.

The present invention is not limited to the embodiments described above, and various changes, modifications and the like can be made within a range not departing from the spirit of the present invention.

What is claimed is:

1. An endoscope image management apparatus comprising:
a folder tree display processing section which displays a folder tree on a screen of a display device, the folder tree including multiple folders in which endoscope image files are registered and multiple higher folders set as a hierarchical layer higher than the multiple folders;
a virtual folder generating section which extracts folder names of lower folders which include at least one endoscope image file, the lower folders being included in each of the multiple higher folders, as virtual folder names, based on folder names of the multiple folders, collects and integrates same folder names, and associates endoscope image files included in folders having a same folder name with the extracted virtual folder;
a virtual folder display processing section which displays the extracted virtual folders on the screen; and
an image display processing section which, when the virtual folder displayed on the screen is selected, displays endoscope images of one or more endoscope image files associated with the selected virtual folder, on the screen.

2. The endoscope image management apparatus according to claim 1, comprising a folder identifiably displaying section which, when the endoscope image displayed on the screen is selected, identifiably displays a folder in which the selected endoscope image is registered and a higher folder at a hierarchical layer higher than the folder in which the endoscope image is registered in the folder tree.

3. The endoscope image management apparatus according to claim 1, wherein the virtual folder display processing section identifiably displays a virtual folder which is such an independent folder that no other folder having a same name exists under a folder higher than the virtual folder.

4. The endoscope image management apparatus according to claim 1, comprising a predetermined image displaying section which, if the virtual folder displayed on the screen is selected and the endoscope image file is not registered in the selected virtual folder, displays a predetermined image showing that the endoscope image file does not exist, on the screen of the display device.

5. The endoscope image management apparatus according to claim 1, wherein, if result information about the endoscope image displayed on the screen is different from result information about an endoscope image before or after a time of registration of the endoscope image, the image display processing section displays a predetermined mark, associating the mark with the endoscope image displayed on the image.

6. The endoscope image management apparatus according to claim 1, wherein the folder tree display processing section displays the folder tree in a first display area on the screen; the virtual folder display processing section displays the virtual folders in a second display area on the screen; and the image display processing section displays the endo scope images in a third display area on the screen.

7. The endoscope image management apparatus according to claim 1, wherein the lower folder is a folder at the lowest layer included in each higher folder.

8. The endoscope image management apparatus according to claim 1, wherein the lower folder is a folder at an intermediate hierarchical layer existing between a folder at the lowest layer included in each higher folder and the higher folder.

9. An endoscope image display method for displaying endoscope images of endoscope image files registered with multiple folders, the method comprising:
displaying a folder tree on a screen of a display device by a folder tree display processing section, the folder tree including the multiple folders in which the endoscope image files are registered and multiple higher folders set as a hierarchical layer higher than the multiple folders;
extracting folder names of lower folders which include at least one endoscope image file, the lower folders being included in each of the multiple higher folders, as virtual folder names, based on folder names of the multiple folders, collecting and integrating same folder names, and associating endoscope image files included in folders having a same folder name with the extracted virtual folder, by a virtual folder generating section;
displaying the extracted virtual folders on the screen by a virtual folder display processing section; and
when the virtual folder displayed on the screen is selected, displaying endoscope images of one or more endoscope image files associated with the selected virtual folder, on the screen, by an image display processing section.

10. The endoscope image display method according to claim 9, comprising: when the endoscope image displayed on the screen is selected, identifiably displaying a folder in which the selected endoscope image is registered and a higher folder at a hierarchical layer higher than the folder in which the endoscope image is registered in the folder tree.

11. The endoscope image display method according to claim 9, comprising: identifiably displaying a virtual folder which is such an independent folder that no other folder having a same name exists under a folder higher than the virtual folder.

12. The endoscope image display method according to claim 9, comprising: if the virtual folder displayed on the screen is selected and the endoscope image file is not registered in the selected virtual folder, displaying a predetermined image showing that the endoscope image file does not exist, on the screen of the display device.

13. The endoscope image display method according to claim 9, comprising: if result information about the endoscope image displayed on the screen is different from result information about an endoscope image before or after a time of registration of the endoscope image, displaying a predetermined mark, associating the mark with the endoscope image displayed on the image.

14. The endoscope image display method according to claim 9, comprising:
displaying the folder tree in a first display area on the screen, displaying the virtual folders in a second display area on the screen, and displaying the endoscope images in a third display area on the screen.

15. The endoscope image display method according to claim 9, wherein the lower folder is a folder at the lowest layer included in each higher folder.

16. The endoscope image display method according to claim 9, wherein the lower folder is a folder at an intermediate hierarchical layer existing between a folder at the lowest layer included in each higher folder and the higher folder.
